(19) United States
(12) Patent Application Publication
(10) Pub. No.: US 2011/0148586 A1
(43) Pub. Date: Jun. 23, 2011

(54) HYGIENE MONITORING SYSTEMS AND METHODS

(76) Inventors: Daniel D. Anderson, Minneapolis, MN (US); Sherman L. Bartz, St. Paul, MN (US); Craig M. Carlson, Vadnais Heights, MN (US); Bernard A. Gonzalez, St. Paul, MN (US); Orlin B. Knudson, Vadnais Heights, MN (US); John M. Kruse, Minneapolis, MN (US); Craig D. Oster, Oakdale, MN (US)

(21) Appl. No.: 12/889,503

(22) Filed: Sep. 24, 2010

Related U.S. Application Data
(60) Provisional application No. 61/245,936, filed on Sep. 25, 2009.
(60) Provisional application No. 61/299,216, filed on Jan. 28, 2010.

(51) Int. Cl. G06K 7/01

(52) U.S. Cl. 340/10.1

(57) ABSTRACT

Hygiene monitoring systems and methods are described herein. In various embodiments, the systems and methods may be used to monitor cleaning events (e.g., hand washing events, equipment sanitation events, etc.).

### RELATED APPLICATIONS

The present application claims the benefit under 35 U.S.C. §119(e) of U.S. Provisional Patent Application No. 61/245,936, filed on Sep. 25, 2009 and U.S. Provisional Patent Application No. 61/299,216, filed on Jan. 28, 2010, both of which are hereby incorporated by reference in their entirety.

### BACKGROUND

Non-compliance with recommended hygiene protocols such as washing or otherwise sanitizing hands before and after patient contact is thought to be a significant contributor in the spread of Healthcare Acquired Infections (HAI's). Each HAI adds cost and, in some instances, time to stays in hospitals and some medical care insurers, such as, e.g., Medicare, have indicated that they will not reimburse healthcare providers for healthcare expenses that are the direct result of at least some HAI's.

Monitoring compliance with hygiene protocols is, as a result, becoming increasingly important to assist health care facilities with measuring compliance with their hygiene protocols.

### SUMMARY

Hygiene monitoring systems and methods are described herein. In some embodiments, the systems and methods may be described as patient-centric and be used to monitor cleaning events (e.g., hand washing events, equipment sanitation events, etc.) associated with people and/or equipment entering and/or exiting a patient zone, where the patient zone is associated with a selected patient. In some embodiments, the patient-centric systems and methods include a patient zone controller associated with a selected patient, with the patient zone controller defining a patient zone for a selected patient, and a hygiene station that is linked to the patient zone controller, with the patient zone controller and the linked hygiene station being used in the monitoring of hygiene protocol compliance.

The systems and methods described herein may, in some embodiments, include one or more patient zone controllers, one or more hygiene stations, and one or more transient credentials. As discussed herein, the patient zone controllers preferably define a patient zone in which a patient may be located, the transient credentials may be transported along with transient objects in health care facility (e.g., people, equipment, etc.) and used to monitor activities associated with the transient objects, and hygiene stations may provide materials and equipment needed to perform cleaning events as described in more detail herein (to, e.g., improve the hygiene of the hands of a person or equipment).

Potential advantages of the patient-centric systems and methods described herein may, in some embodiments, include the ability to monitor hygiene protocol compliance at a local level defined by the patient zone. Monitoring hygiene protocol compliance at the local level may, in some embodiments, reduce data traffic within a health care facility and/or provide the ability to provide hygiene compliance to locations where such compliance systems may not be otherwise economically provided.

In some embodiments, hygiene monitoring systems and methods of commissioning hygiene stations for use in the systems are described herein. In various embodiments, the systems and methods may be used to retrofit existing hygiene stations in a health care facility with cleaning event detectors. As a result, hygiene protocol compliance can be monitored even in health care facilities that include two or more different types of hygiene stations. The retrofitting may or may not be used in conjunction with the patient-centric hygiene systems and methods described herein.

In a first aspect, some embodiments of a system for monitoring hygiene practices as described herein include: a plurality of hygiene stations, wherein each hygiene station of the plurality of hygiene stations comprises on-board memory operably connected to a communication device, wherein at least some data transmitted by the communication device is stored in the on-board memory of the hygiene station, wherein; a patient zone controller configured to define a patient zone proximate the selected patient, wherein the patient zone controller is linked to a hygiene station of the plurality of hygiene stations, wherein the patient zone controller comprises on-board memory operably connected to a communication device, wherein at least some data transmitted by the communication device is stored in the on-board memory of the patient zone controller, and wherein the patient zone controller is associated with only one selected patient; a plurality of transient credentials, wherein each transient credential comprises on-board memory operably connected to a communication device, wherein at least some data transmitted by the transceiver is stored in the on-board memory of the transient credential, and wherein the transient credential is associated with a transient object.

In some embodiments of the systems of the first aspect, the system is configured to: detect the occurrence of a cleaning event at the linked hygiene station; associate a transient credential of the plurality of transient credentials with the cleaning event; and store data identifying the transient credential associated with the cleaning event in the patient zone controller.

In some embodiments of the systems of the first aspect, the patient zone controller is configured to: detect entry of a transient credential of the plurality of credentials into the patient zone defined by the patient zone controller; and optionally to determine if the detected transient credential is associated with a cleaning event at the hygiene station linked to the patient zone controller, optionally within a selected time period relative to detection of the entry.

In some embodiments of the systems of the first aspect, the patient zone controller is configured to: detect exit of a transient credential of the plurality of credentials from the patient zone defined by the patient zone controller; and optionally to determine if the detected transient credential is associated with a cleaning event at the hygiene station linked to the patient zone controller, optionally within a selected time period relative to detection of the exit.

In some embodiments of the systems of the first aspect, each transient credential of the plurality of transient credentials is configured to: detect entry of the transient credential into the patient zone defined by the patient zone controller; and optionally to determine if the detected transient credential is associated with a cleaning event at the hygiene station linked to the patient zone controller, optionally within a selected time period relative to detection of the entry.

In some embodiments of the systems of the first aspect, each transient credential of the plurality of transient credentials is configured to: detect exit of a transient credential from the patient zone defined by the patient zone controller; and optionally to determine if the detected transient credential is associated with a cleaning event at the hygiene station linked to the patient zone controller, optionally within a selected time period relative to detection of the exit.

In some embodiments of the systems of the first aspect, the linked hygiene station is configured to: detect entry of a transient credential of the plurality of credentials into the patient zone defined by the patient zone controller; and optionally to determine if the detected transient credential is associated with a cleaning event at the linked hygiene station linked to the patient zone controller, optionally within a selected time period relative to detection of the entry.

In some embodiments of systems of the first aspect, the linked hygiene station is configured to: detect exit of a transient credential of the plurality of credentials from the patient zone defined by the patient zone controller; and optionally to determine if the detected transient credential is associated with a cleaning event at the hygiene station linked to the patient zone controller, optionally within a selected time period relative to detection of the exit.

In some embodiments of the systems of the first aspect, the patient zone controller is configured to store compliance data, wherein the compliance data comprises data indicative of the determination that the transient credential detected in the patient zone is or is not associated with the cleaning event at the linked hygiene station, optionally within the selected time period.

In some embodiments of the systems of the first aspect, each transient credential of the plurality of transient credentials is configured to store compliance data, wherein the compliance data comprises data indicative of the determination that the transient credential detected in the patient zone is or is not associated with the cleaning event at the linked hygiene station, optionally within the selected time period.

In some embodiments of the systems of the first aspect, the linked hygiene station is configured to store compliance data, wherein the compliance data comprises data indicative of the determination that the transient credential detected in the patient zone is or is not associated with the cleaning event at the linked hygiene station, optionally within the selected time period.

In some embodiments of the systems of the first aspect, the patient zone controller is configured to define a first patient zone and a second patient zone, wherein the first patient zone is different than the second patient zone. In some embodiments, the first patient zone is larger than the second patient zone. In some embodiments, the patient zone controller is configured to define the first patient zone and the second patient zone at the same time, wherein the first patient zone and the second patient zone define a multi-tiered patient zone. In some embodiments, the patient zone controller is configured to select one of the first patient zone and a second patient zone based on criteria associated with the selected patient associated with the patient zone controller. In some embodiments, the patient zone controller is configured to select one of the first patient zone and a second patient zone based on a determination that the selected patient is moving between a first location and second location within a health care facility.

In some embodiments of the systems of the first aspect, the linked hygiene station is located within the patient zone.

In some embodiments of the systems of the first aspect, a hygiene station of the plurality of hygiene stations is linked to two or more patient zone controllers at the same time.

In some embodiments of the systems of the first aspect, the patient zone controller is linked to two or more hygiene stations of the plurality of hygiene stations at the same time. In some embodiments, at least one of the two or more hygiene stations linked to the patient zone controller is located within the patient zone.

In some embodiments of the systems of the first aspect, the system further comprises a central controller, and wherein at least one of the linked hygiene station, the patient zone controller, and the transient credential is operably connected to the central controller, and wherein the system comprises a plurality of patient zone controllers.

In some embodiments of the systems of the first aspect including a central controller, the patient zone controller is configured to: detect entry of a transient credential of the plurality of credentials into the patient zone defined by the patient zone controller; and communicate data to the central controller indicating entry of the transient credential into the patient zone and association of the transient credential with a cleaning event. Optionally, the patient zone controller may also determine if the detected transient credential is associated with a cleaning event at the hygiene station linked to the patient zone controller, optionally within a selected time period relative to detection of the entry.

In some embodiments of the systems of the first aspect including a central controller, the patient zone controller is configured to: detect exit of a transient credential of the plurality of credentials from the patient zone defined by the patient zone controller; and communicate data to the central controller indicating exit of the transient credential from the patient zone and association of the transient credential with a cleaning event. Optionally, the patient zone controller may also determine if the detected transient credential is associated with a cleaning event at the hygiene station linked to the patient zone controller, optionally within a selected time period relative to detection of the exit.

In some embodiments of the systems of the first aspect including a central controller, each transient credential of the plurality of transient credentials is configured to: detect entry of the transient credential into the patient zone defined by the patient zone controller; and communicate data to the central controller indicating entry of the transient credential into the patient zone and association of the transient credential with a cleaning event. Optionally, each transient credential may also determine if the detected transient credential is associated with a cleaning event at the hygiene station linked to the patient zone controller, optionally within a selected time period relative to detection of the entry.

In some embodiments of the systems of the first aspect including a central controller, each transient credential of the plurality of transient credentials is configured to: detect exit of a transient credential from the patient zone defined by the patient zone controller; and communicate data to the central controller indicating exit of the transient credential from the patient zone and association of the transient credential with a cleaning event. Optionally, each transient credential may also determine if the detected transient credential is associated with a cleaning event at the hygiene station linked to the patient zone controller, optionally within a selected time period relative to detection of the exit.

In some embodiments of the systems of the first aspect including a central controller, the linked hygiene station is configured to: detect entry of a transient credential of the plurality of credentials into the patient zone defined by the patient zone controller; and communicate data to the central controller indicating entry of the transient credential into the patient zone and association of the transient credential with a cleaning event. Optionally, the linked hygiene station may also determine if the detected transient credential is associated with a cleaning event at the linked hygiene station linked to the patient zone controller, optionally within a selected time period relative to detection of the entry.

In some embodiments of the systems of the first aspect including a central controller, the linked hygiene station is configured to: detect exit of a transient credential of the plurality of credentials from the patient zone defined by the patient zone controller; and communicate data to the central controller indicating exit of the transient credential from the patient zone and association of the transient credential with a cleaning event. Optionally, the linked hygiene station may also determine if the detected transient credential is associated with a cleaning event at the hygiene station linked to the patient zone controller, optionally within a selected time period relative to detection of the exit.

In some embodiments of the systems of the first aspect including a central controller, the central controller is configured to store compliance data, wherein the compliance data comprises data indicative of the determination that the transient credential detected in the patient zone is or is not associated with the cleaning event at the linked hygiene station, optionally within the selected time period.

In a second aspect, methods of monitoring hygiene compliance as described herein may include associating a patient zone controller with a selected patient; defining a patient zone using a patient zone controller; linking a hygiene station to the patient zone controller; detecting entry of a transient credential into the patient zone defined by the patient zone controller; and determining if the transient credential is associated with a cleaning event at the linked hygiene station.

In some embodiments of methods of the second aspect, linking the hygiene station to the patient zone controller comprises communication between the linked hygiene station and the patient zone controller.

In some embodiments of methods of the second aspect, linking the hygiene station to the patient zone controller occurs when the hygiene station enters the patient zone defined by the patient zone controller.

In some embodiments of methods of the second aspect, the linking comprises determining if the hygiene station is acceptable for the selected patient associated with the patient zone controller.

In some embodiments of methods of the second aspect, the transient credential is associated with a health care worker.

In some embodiments of methods of the second aspect, the patient zone controller defines a first patient zone and a second patient zone, wherein the first patient zone is different than the second patient zone. In some embodiments, the first patient zone is larger than the second patient zone. In some embodiments, the patient zone controller defines the first patient zone and the second patient zone at the same time, wherein the first patient zone and the second patient zone define a multi-tiered patient zone. In some embodiments, one of the first patient zone and a second patient zone is selected based on criteria associated with the selected patient associated with the patient zone controller. In some embodiments, one of the first patient zone and a second patient zone is selected based on a determination that the selected patient is moving between a first location and second location within a health care facility.

In some embodiments of methods of the second aspect, the method further comprises linking a hygiene station of the plurality of hygiene stations to two or more patient zone controllers.

In some embodiments of methods of the second aspect, the method further comprises linking the patient zone controller to two or more hygiene stations of the plurality of hygiene stations. In some embodiments, at least one of the two or more hygiene stations linked to the patient zone controller is located within the patient zone.

In some embodiments of methods of the second aspect, the method further comprises: detecting the occurrence of a cleaning event at the linked hygiene station; associating the transient credential detected as entering the patient zone with the cleaning event.

In some embodiments of methods of the second aspect, the patient zone controller detects entry of the transient credential into the patient zone defined by the patient zone controller. In some embodiments, the patient zone controller determines if the detected transient credential is associated with a cleaning event at the hygiene station linked to the patient zone controller, optionally within a selected time period relative to detection of the entry. In some embodiments, the patient zone controller reports the detected entry of the transient credential into the patient zone defined by the patient zone controller to a central controller. In some embodiments, the central controller determines if the detected transient credential is associated with a cleaning event at the hygiene station linked to the patient zone controller, optionally within a selected time period relative to detection of the entry.

In some embodiments of methods of the second aspect, the patient zone controller detects exit of the transient credential from the patient zone defined by the patient zone controller. In some embodiments, the patient zone controller determines if the detected transient credential is associated with a cleaning event at the hygiene station linked to the patient zone controller, optionally within a selected time period relative to detection of the exit. In some embodiments, the patient zone controller reports the detected exit of the transient credential from the patient zone defined by the patient zone controller to a central controller. In some embodiments, the central controller determines if the detected transient credential is associated with a cleaning event at the hygiene station linked to the patient zone controller, optionally within a selected time period relative to detection of the exit.

In some embodiments of methods of the second aspect, the transient credential detects entry of the transient credential into the patient zone defined by the patient zone controller. In some embodiments, the detected transient credential determines if the detected transient credential is associated with a cleaning event at the hygiene station linked to the patient zone controller, optionally within a selected time period relative to detection of the entry. In some embodiments, the detected transient credential reports the detected entry of the transient credential into the patient zone defined by the patient zone controller to a central controller. In some embodiments, the central controller determines if the detected transient credential is associated with a cleaning event at the hygiene station linked to the patient zone controller, optionally within a selected time period relative to detection of the entry.

In some embodiments of methods of the second aspect, the transient credential detects exit of the detected transient credential from the patient zone defined by the patient zone controller. In some embodiments, the detected transient credential determines if the detected transient credential is associated with a cleaning event at the hygiene station linked to the patient zone controller, optionally within a selected time period relative to detection of the exit. In some embodiments, the transient credential reports the detected exit of the transient credential from the patient zone defined by the patient zone controller to a central controller. In some embodiments, the central controller determines if the detected transient credential is associated with a cleaning event at the hygiene station linked to the patient zone controller, optionally within a selected time period relative to detection of the exit.

In some embodiments of methods of the second aspect, the linked hygiene station detects entry of the detected transient credential into the patient zone defined by the patient zone controller. In some embodiments, the linked hygiene station determines if the detected transient credential is associated with a cleaning event at the linked hygiene station linked to the patient zone controller, optionally within a selected time period relative to detection of the entry. In some embodiments, the linked hygiene station reports the detected entry of the transient credential into the patient zone defined by the patient zone controller to a central controller. In some embodiments, the central controller determines if the detected transient credential is associated with a cleaning event at the hygiene station linked to the patient zone controller, optionally within a selected time period relative to detection of the entry.

In some embodiments of methods of the second aspect, the linked hygiene station detects exit of the detected transient credential from the patient zone defined by the patient zone controller. In some embodiments, the linked hygiene station determines if the detected transient credential is associated with a cleaning event at the hygiene station linked to the patient zone controller, optionally within a selected time period relative to detection of the exit. In some embodiments, the linked hygiene station reports the detected exit of the transient credential from the patient zone defined by the patient zone controller to a central controller. In some embodiments, the central controller determines if the detected transient credential is associated with a cleaning event at the hygiene station linked to the patient zone controller, optionally within a selected time period relative to detection of the exit.

In a third aspect, some embodiments of methods of selecting a hygiene protocol for use in a patient zone as described herein include: associating a selected patient with a patient zone; identifying a patient-based factor associated with the selected patient; selecting a hygiene protocol to apply in the patient zone based on the identified patient-based factor; and applying the selected hygiene protocol upon entry of a transient credential into the patient zone. In some embodiments, the patient-based factor is selected from the group consisting of: the health of the patient, the type of illness or condition from which the patient suffers, and whether the patient is moving through the facility.

In a fourth aspect, some embodiments of methods of selecting a hygiene protocol for use in a patient zone as described herein include: associating a selected patient with a patient zone; identifying an environmental factor associated with the environment in which the patient zone is located; selecting a hygiene protocol to apply in the patient zone based on the identified environmental factor; and applying the selected hygiene protocol upon entry of a transient credential into the patient zone. In some embodiments, the environmental factor is selected from the group consisting of: the type of health care facility in which the patient zone is located, the time of day, the day of the week, the time of year, the existence of an outbreak of contagious illness near the patient zone; and the existence of an outbreak of contagious illnesses in the community in which the patient zone is located.

In a fifth aspect, some embodiments of methods of selecting a hygiene protocol for use in a patient zone as described herein include: associating a selected patient with a patient zone; optionally identifying a location of the patient zone; identifying the historical hygiene protocol compliance rate of the location in which the patient zone is located; and selecting a hygiene protocol to apply in the patient zone based on the identified historical hygiene protocol compliance rate; and applying the selected hygiene protocol upon entry of a transient credential into the patient zone.

In a sixth aspect, some embodiments of methods of selecting a hygiene protocol for use in a patient zone as described herein include: detecting entry of a transient credential into a patient zone; identifying a factor associated with the transient credential entering the patient zone; selecting a hygiene protocol to apply in the patient zone to entry of the transient credential based on the factor associated with the entering transient credential; and applying the selected hygiene protocol upon entry of a transient credential into the patient zone. In some embodiments, the factor associated with the transient credential is selected from the group consisting of: a historical hygiene protocol compliance rate associated with the transient credential, a group associated with the transient credential, and a historical hygiene protocol compliance rate associated with a group associated with the transient credential.

The words “preferred” and “preferably” refer to embodiments that may afford certain benefits, under certain circumstances. However, other embodiments may also be preferred, under the same or other circumstances. Furthermore, the recitation of one or more preferred embodiments does not imply that other embodiments are not useful, and is not intended to exclude other embodiments from the scope of the invention.

As used herein, “a,” “an,” “the,” “at least one,” and “one or more” are used interchangeably. Thus, for example, a hygiene station may be used to refer to one, two, three or more hygiene stations.

The term “and/or” means one or all of the listed elements or a combination of any two or more of the listed elements.

The above summary is not intended to describe each embodiment or every implementation of the hygiene monitoring systems and methods described herein. Rather, a more complete understanding of the hygiene monitoring systems described herein will become apparent and appreciated by reference to the following Description of Illustrative Embodiments and claims in view of the accompanying figures of the drawing.

### BRIEF DESCRIPTION OF DRAWINGS

FIG. 1 is a block diagram of one embodiment of a system including a patient zone controller, a hygiene station, and a transient credential.

FIG. 1A is a diagram illustrating one embodiment of a dual mode communication system.

FIG. 1B is a block diagram of one embodiment of a system including a plurality of patient zone controllers, a plurality of hygiene stations, a plurality of transient credentials, and a central controller.

FIG. 2 is a diagram illustrating one portion of one embodiment of a method of monitoring hygiene protocol compliance as described herein.

FIG. 3A is a diagram illustrating another portion of one embodiment of a method of monitoring hygiene protocol compliance for patient zone entry events as described herein.

FIG. 3B is a diagram illustrating another portion of one embodiment of a method of monitoring hygiene protocol compliance for patient zone exit events as described herein.

FIG. 4 depicts one embodiment of a patient zone controller that may be used in connection with some embodiments of the systems described herein.

FIG. 5 depicts another embodiment of a patient zone controller defining multiple patient zones as described herein.

FIGS. 6A-6C depict embodiments of methods of selecting hygiene protocols for a patient zone.

FIG. 7 depicts a portion of one embodiment of a system in which multiple patient zone controllers are linked with the same hygiene station as described herein.

FIG. 8 depicts a portion of one embodiment of a system in which multiple hygiene stations are linked with the same patient zone controller as described herein.

FIG. 9 is a block diagram of one embodiment of a system including two retrofitted hygiene stations and other components.

FIG. 10 is a diagram depicting some portions of a commissioning process for a cleaning event detector to be associated with a hygiene apparatus.

### DESCRIPTION OF ILLUSTRATIVE EMBODIMENTS

In the following description of illustrative embodiments, reference is made to the accompanying figures of the drawing which form a part hereof, and in which are shown, by way of illustration, specific embodiments in which the systems and/or methods described herein may be practiced. It is to be understood that other embodiments may be utilized and structural changes may be made without departing from the scope of the present invention.

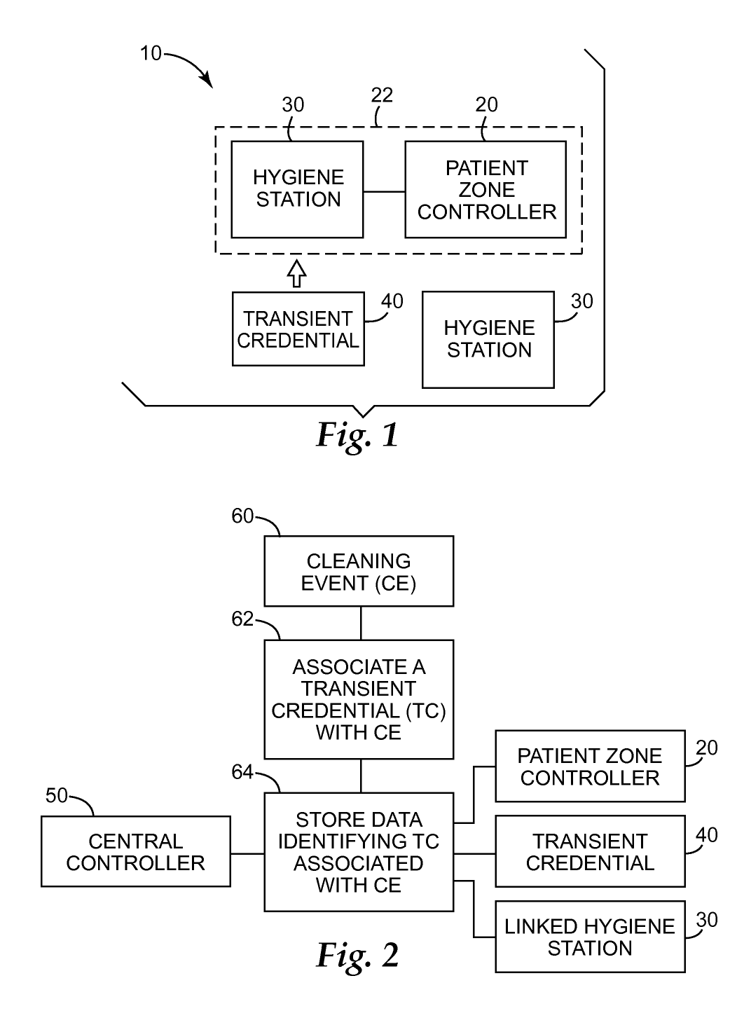

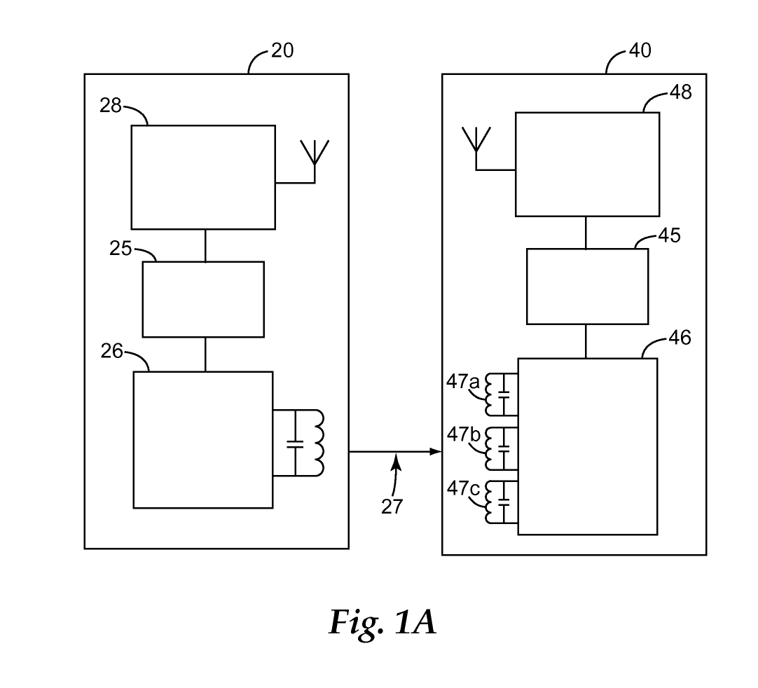

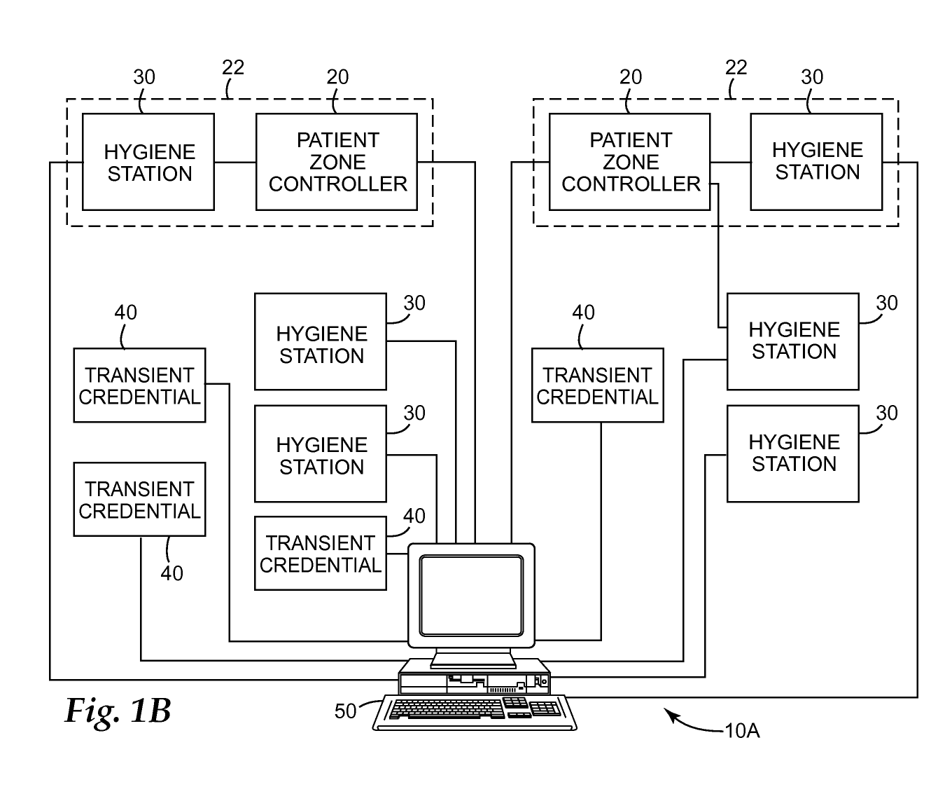

One embodiment of a system 10 for monitoring hygiene protocol compliance is depicted in FIG. 1. The system 10 as depicted in FIG. 1 includes an optional patient zone controller 20 which defines a patient zone 22 as described herein. The patient zone controller 20 in the system 10 is linked to a hygiene station 30. The system 10 depicted in FIG. 1 includes another hygiene station 30 that is not linked to any patient zone controller (although, as discussed herein, multiple hygiene stations may be linked to the same patient zone controller in some embodiments). Although two hygiene stations are depicted in system 10, the number of hygiene stations provided within a system as described herein may vary from as few as one hygiene station to two, three, or more hygiene stations.

The system 10 further includes a transient credential 40 that is typically attached or otherwise associated with people or equipment that may move into and/or out of the patient zone 22 defined by the patient zone controller 20. Although FIG. 1 includes only one transient credential 40, the number of transient credentials 40 provided within a system may vary from as few as one transient credential 40 to two, three, four or more transient credentials.

The various components of the system 10 may be configured to operate in manners as described herein to monitor hygiene protocol compliance within any selected health care facility. As used herein, the term “health care facility” may include a variety of environments including, for example, hospitals, long-term care facilities, health clinics, home health care environments, or any other patient-occupied setting.

The patient zone controllers of systems as described herein may preferably include, in various embodiments, a communication device capable of transmitting and/or receiving data and on-board memory that is operably connected to the communication device to store received data and/or transmit stored data as a part of the operation of the system. The operable connection between the on-board memory and the communication device may typically be performed by a controller that is also preferably resident on or in the patient zone controller. Examples of some potentially suitable controllers may include, e.g., an Application Specific Integrated Circuit (ASIC) state machine, a gate array, a microprocessor, a microcontroller, etc. The controller in a patient zone controller may also, in some embodiments, be used to control operation of the patient zone and other functions of the patient zone controller as described herein.

The patient zone controllers used in systems and methods described herein may be provided in any format that is capable of providing the functions of a patient zone controller as described herein. In some embodiments, the patient zone controller 20 may be in the form of a mobile badge or other device that can be carried by or otherwise attached to the selected person (e.g., a patient) or piece of equipment in or on which the patient is located (e.g., a wheelchair, bed, etc.) in a health care facility in which the systems described herein are used. In some embodiments, the patient zone controllers 20 may be stationary devices positioned at fixed locations in a health care facility such that the patient zone controllers do not move with patients. In still other embodiments of systems and methods described herein, some of the patient zone controllers may be mobile devices while others may be stationary.

Each of the patient zone controllers as described herein preferably includes data associating the patient zone controller with only one selected patient. In some embodiments, the data associating the patient zone controller with a selected patient may be variable, i.e., may be changed as a part of the operation of the system by, for example, entering unique patient identification data into the system when the patient zone controller is assigned to the selected patient. In other embodiments, the data associating the patient zone controller with a selected patient may be fixed, i.e., the patient zone controller may itself contain unique identifying data that is assigned to the selected patient when the patient zone controller is issued or otherwise associated with the selected patient. In either case, the unique identifying data (whether unique to the patient or the patient zone controller) may, in some systems, be used to facilitate maintenance of the associated patient's Electronic Medical Record (EMR) as a part of the hygiene monitoring.

The patient zone controllers of the systems described herein, such as patient zone controller 20, are also preferably configured to define one or more patient zones, where the patient zones define one or more areas in which entry into and/or exit of other components from the patient zone 20 (such as a transient credential 40) can be detected.

By “define” as used in connection with the patient zones defined by the patient zone controllers described herein, it is meant that a patient zone controller preferably includes the components (e.g., hardware, processors, software, sensors, transducers, etc.) required to establish, form, emit, etc. the patient zones described herein. While the patient zone controller may, in some embodiments, be provided as a one-piece integrated unit contained within a single housing, in other embodiments, the patient zone controller may take the form of two or more components such a main housing and operably connected emitters, sensors, etc. as required to define the patient zone(s) for the particular patient zone controller, where at least one of the components is not contained within the main housing.

The patient zones defined by the patient zone controllers of the systems described herein may preferably be large enough to contain a patient such that physical contact with the patient is typically not possible without a detectable entry into the patient zone 22, although in some instances as described herein, the size of the patient zone may be reduced such that the patient is not entirely contained within the patient zone 22 to, e.g., facilitate patient movement within the healthcare facility, etc.

In some embodiments, the boundaries of the patient zones defined by the patient zone controllers may be somewhat variable depending on the technology used to define the patient zone, i.e., the boundaries of the patient zone may not necessarily be as distinct as the line depicted the zone boundary in FIG. 1. Examples of some potentially suitable technologies that may be incorporated into the patient zone controller to define the one or more patient zones such that entry into and/or exit from the patient zone may be detected may include, for example, RF (Radio Frequency) reflection, acoustic reflection (using, e.g., ultrasonic energy, etc.), RFID (Radio Frequency Identification) detection, LIDAR (Light Detection and Ranging), infrared detection and/or imaging, optical imaging, capacitive detection, pressure sensing mats, etc.

RF reflection is a technique in which a Radio Frequency (RF) signal is emitted from an emitter. Items (e.g., people, equipment, etc.) entering a patient zone are detected if they reflect the RF signal back to a detector. Acoustic reflection detection is performed by emitting acoustic energy (e.g., ultrasonic energy) and detecting the acoustic energy that is reflected by a zone entrant. RFID detection is performed by transmitting an initiating RF signal within the patient zone and detecting a predetermined return RF signal emitted by an RFID tag (associated with, e.g., a transient credential) that receives the initiating RF signal because it is located within the patient zone. Optical techniques for zone entry detection may include, e.g., disruption of a light beam and LIDAR (which is another reflection technique relying on an emitter and detector combination—in some embodiments, LIDAR can also be used for detection through optical imaging). Optical image processing can be used to capture images, with the images used for zone detection. Pressure mats typically detect the presence of an individual (e.g., nurse, doctor, etc.) stepping on the mat and/or the presence of a piece of equipment (e.g., an IV stand, blood pressure monitor, etc.) located on the pressure mat. The zone detection techniques described herein are not meant to be exhaustive, virtually any technology that can be used to detect entry into and/or exit from a zone can be used in connection with the hygiene monitoring systems and methods described herein.

Another technology that may be incorporated into the systems described herein may include the dual mode communication schemes commonly used in the “passive keyless entry” systems employed in connection with automobiles and other vehicles. The patient zone controllers, transient credentials and/or hygiene stations may, in various embodiments, be equipped with dual mode communication devices.

Referring to, e.g., FIG. 1A, the patient zone controller 20 is equipped with a dual mode communication system that includes a controller 25 and a low frequency (LF) transmitter 26 along with data transceiver 28. The system may also include a transient credential 40 that is equipped with a dual mode communication system that includes a controller 45 and a low frequency (LF) transmitter 46 and a data transceiver 48.

The LF transmitter 26 of the patient zone controller 20 preferably emits a low frequency signal 27 (e.g., 125 kHz) periodically and/or continuously that can be used to activate or “wake-up” the data transceiver 48 in a transient credential 40 that detects the LF signal. In essence, the patient zone controller 20 with its associated LF transmitter 26 functions to define the patient zone around the patient zone controller 20 based on the strength of the LF signal 27 emitted by the LF transmitter 26. Any transient credential 40 detecting the LF signal 27 at a selected signal strength level can then be considered as having entered the patient zone defined by the patient zone controller 20, and that entry results in activation of the data transceiver 48 of the transient credential 40.

Activation of the data transceiver 48 in the transient credential 40 may be accomplished by, e.g., reception of the LF signal 27 emitted by the LF transmitter 26 by the LF receiver 46 of the transient credential 40. A LF wireless channel is used to accomplish activation of the data transceiver 48 in the transient credential 40 when the transient credential 40 is within the patient zone of the patient zone controller 20. When activated, the data transceiver 48 of the transient credential 40 preferably communicates by emitting and receiving signals in the UHF (ultra high frequency) band, e.g., at 433 MHz. Communicating data in the UHF band can significantly reduce the time required to send and receive data between the communicating devices. That reduction in time required for data communication when using the UHF band can increase system response time and battery life. The higher data transmission rates may also allow for the use of encryption for a more secure communication link.

As discussed above, after the transient credential 40 “wakes-up” in response to receiving the LF signal from the LF transmitter 26 of the patient zone controller 20, the transient credential 40 may preferably transmit its identity to the patient zone controller 20 (or any other device with an appropriate data transceiver) for authentication using the data transceiver 48. By essentially operating in a low-power consumption mode in which the data transceiver 48 is not powered up, additional battery life savings may also be achieved.

Another potential advantage of using LF wavelength signals to activate the transient credential 40 is that the long wavelengths used in the LF signal (e.g., 125 kHz) are not as attenuated by metal or humans as are shorter wavelength signals. As a result, detection of the LF signal by the LF receiver 46 of the transient credential 40 is not adversely affected by the location of the transient credential on, e.g., a health care worker, etc. In other words, the transient credential 40 may be out of the line of sight of the LF transmitter 26 of the patient zone controller 20, but the LF signal emitted by the LF transmitter 26 may, nonetheless, still be detected by the LF receiver 46 of the transient credential 40.

Furthermore, the ability to detect the LF signal emitted by the LF transmitter 26 may also allow for accurate determination of the proximity between the transient credential 40 and the patient zone controller 20 based on signal strength measurements. As a result, the LF signal can be used to define the patient zone 22 as discussed herein based on detected signal strength for the LF signal.

In some embodiments, the LF receiver 46 of the transient credential 40 may include two or more antennas, with the different antennas mounted orthogonally relative to each other to improve the ability of the LF receiver 46 to receive LF signals in a variety of different orientations. If the LF receiver 46 includes three different antennas 47a-47c as depicted in FIG. 1A and the three different antennas are oriented orthogonally to each other (as in, e.g., an x-y-z coordinate system), then the ability of the LF receiver to receive LF signals from the LF transmitter 26 can be improved regardless of the orientation of the transient credential 40.

Although the embodiments of system described herein in connection with FIG. 1A include an LF transmitter and an LF receiver for proximity detection and activation of the system devices, with data communication being performed by separate transceivers, both of the devices could use LF transceivers if the speed of data transmission and/or power consumption were not as important.

In some embodiments, the hygiene stations 30 used in systems that include a patient zone controller 20 may also incorporate the same communication schemes and devices as those described in connection with the transient credential 40 of FIG. 1A. For example, the LF transmitter 26 of the patient zone controller 20 may be used to activate a hygiene station 30 that comes within range of the LF signal 27 emitted by the LF transmitter 26 of the patient zone controller 20 (i.e., that is located within the patient zone defined by the LF signal 27). That activation may occur based on reception of the LF signal by a corresponding LF receiver of the hygiene station 30 in a manner similar to that described above in connection with the transient credential 40.

Examples of some potentially useful dual-mode communication systems that may be used in connection with the patient zone controller communications systems using separate LF transmitters and receivers along with separate data transceivers may be described in, e.g., U.S. Pat. No. 6,747,545 (Nowottnick et al.); U.S. Patent Application Publication No. US 2009/0256674 (Lee et al.); etc. Other systems that may be used to accomplish the same result may be described in, e.g., U.S. Patent Application Publication No. US 2008/0284564 (Leitch).

Returning to FIG. 1, the systems and methods described herein may include one or more hygiene stations 30. The hygiene stations of the systems described herein may take a variety of different forms. Examples of some suitable hygiene stations that can be used to improve the hygiene of the hands of a health care worker, visitor, patient, etc. may include, e.g., soap dispensers, sinks (in combination, e.g., with soap dispensers), antiseptic hand sanitizer dispensers, towelette dispensers (where the towelettes preferably include some form of suitable antiseptic cleanser), glove dispensers, UV disinfectant stations, etc. In the case of hand hygiene, a cleaning event can be described as, e.g., a technique that can be used to provide a person with sanitary hands through, e.g., washing, the use of sanitizing materials/techniques, covering the hands using sterile gloves, etc. In some embodiments, the hygiene stations used in the systems and methods described herein may be used to clean (or be capable of cleaning) equipment such as, e.g., stethoscopes, monitoring/diagnostic equipment (e.g., blood pressure monitors, blood oxygen monitors, cardiac monitors, etc.), intravenous equipment (e.g., IV stands, infusion pumps, etc.); etc. As used in connection with equipment, a cleaning event can be described as, e.g., a technique that can be used to sanitize appropriate portions of the equipment (e.g., the portions of a stethoscope that contact a patient or the hands of a user of the stethoscope, etc.).

In addition to the components needed to provide a cleaning event for a person and/or equipment, the hygiene station may also preferably include, in various embodiments, a communication device capable of transmitting and/or receiving data and on-board memory that is operably connected to the communication device to store received data and/or transmit stored data as a part of the operation of the system. The operable connection between the on-board memory and the communication device may typically be performed by a controller that is also preferably resident on or in the hygiene station. Examples of some potentially suitable controllers may include, e.g., an Application Specific Integrated Circuit (ASIC) state machine, a gate array, a microprocessor, a microcontroller, etc.

In systems that include two or more hygiene stations, the hygiene stations used in connection with any particular system may be the same, e.g., the system may be implemented with only sinks, only antiseptic hand sanitizer dispensers, etc. More typically, however, a system as described herein may be implemented with a variety of two or more different hygiene station technologies including, e.g., sinks, antiseptic hand sanitizer dispensers, stethoscope cleaners, etc.

The hygiene stations used in connection with the systems described herein are preferably capable of determining the occurrence of a cleaning event by any suitable technology and may, in some embodiments, also preferably be capable of transmitting data associated with the occurrence of a cleaning event for use by other components in the system. Descriptions of some potentially suitable approaches to detecting cleaning events (such as, e.g., hand washing events) at a hygiene station may be described in a variety of documents, including, for example: U.S. Pat. No. 7,375,640 (Plost); U.S. Pat. No. 7,248,933 (Wildman); U.S. Pat. No. 7,242,307 (LeBlond et al.); U.S. Pat. No. 6,882,278 (Winings et al.); U.S. Pat. No. 6,727,818 (Wildman et al.); U.S. Pat. No. 6,426,701 (Levy); U.S. Pat. No. 6,392,546 (Smith); U.S. Pat. No. 5,952,924 (Evans et al.); U.S. Pat. No. 5,202,666 (Knippscheer); etc. Other techniques and/or apparatus to provide cleaning events, detect cleaning events, and/or communicate data associated with cleaning events may be used, i.e., the provided examples are not intended to be exclusive of other approaches.

In some embodiments of the systems described herein, at least one hygiene station is linked with a patient zone controller. As used herein, a “link” between a patient zone controller and a hygiene station means that the two components are associated with each other in the system. The link may be embodied in linking data contained in one or both of a linked pair of a patient zone controller and a hygiene station. If the linking data is stored on the patient zone controller, for example, it will typically identify the linked hygiene station(s). If the linking data is stored on the linked hygiene station, it will typically identify the linked patient zone controller for that hygiene station. Linking data may also be stored on other components in the system, e.g., central controller, transient credentials, etc., but any such linking data storage would be in addition to the linking data stored locally on the linked patient zone controller and hygiene station.

In addition to or in place of the linking data stored on one or both of the linked patient zone controller and hygiene station, the “link” between a patient zone controller and a hygiene station may be embodied in a communication link. Any such communication link may be continuous or periodic. Further, it may be preferred that the communication link be direct, i.e., that the transfer of data between the linked patient zone controller and hygiene station not be required to travel through a central controller used in connection with two or more patient zone controllers (as described in connection with, e.g., FIG. 1B). In some embodiments, the linked patient zone controller and hygiene station may also be capable of communicating (i.e., transferring data to one or the other) through other components in the system, e.g., central controller, transient credentials, etc., but any such communication link would be in addition to the local communication link established between the patient zone controller and hygiene station.

In some embodiments, the patient zone controller 20 and the linked hygiene station 30 may be provided as separate and discrete components that are linked to each other only by a communication link through which data can be transmitted and received. In other embodiments, the patient zone controller 20 and the linked hygiene station 30 may be integrated into a single unit that performs the different functions of both components.

As discussed herein, the link between the patient zone controller 20 and the hygiene station 30 may be used as a part of the hygiene protocol compliance monitoring process, with the first level of compliance monitoring based on the linked hygiene station 30 and its associated with a patient zone controller 20. In other words, in some embodiments of systems as described herein, the entry detection and corresponding determination of the occurrence of a cleaning event associated with a detected transient credential (or other zone entrant) may preferably be performed by the patient zone controller 20 and/or its linked hygiene station 30.

Even in systems described herein that include an optional central controller, the hygiene protocol compliance may begin by detecting zone entry and analyzing the hygiene status of the detected transient credential with respect to the linked hygiene station before or at the same time as analyzing the hygiene status of the detected transient credential on a wider (e.g., system-wide) basis.

In some embodiments, the linking of a patient zone controller 20 and a hygiene station 30 may be accomplished automatically when, for example, the hygiene station 30 enters a patient zone as defined by a patient zone controller 20. In other embodiments, the linking may require some action on the part of an individual. For example, a health care worker may physically assign a specific hygiene station 30 to a specific patient zone controller 20 by, e.g., entering data into one or both of the patient zone controller 20 and hygiene station 30; establishing a communication link between the patient zone controller 20 and the hygiene station 30 (using, e.g., a cable, port, Bluetooth, IR or other communication link); scanning optical indicia on one or both of the patient zone controller 20 and the hygiene station 30; etc.

In some embodiments, the linking between the patient zone controller 20 and the hygiene station 30 may be performed locally such that data is entered or exchanged between one or both of the patient zone controller 20 and/or the linked hygiene station 30. In other embodiments, the linking between the patient zone controller 20 and the hygiene station 30 may be performed using, e.g., an optional central controller or other component. In either case, the end result is that the patient zone controller 20 and the hygiene station 30 are linked with each other and function within the system as described herein.

In some embodiments of systems as described herein, the linking between a hygiene station 30 and a patient zone controller 20 may be selectively controlled such that, for example, a hygiene station 30 of a particular type may or may not be acceptable as a linked hygiene station 30. Such control may be based, for example, on one or more characteristics of the selected patient associated with a patient zone controller 20. For example, some patient zone controllers 20 may be configured to accept linking only with certain types of hygiene stations 30 (e.g., sinks, etc.). Alternatively, the patient zone controllers 20 may be configured to reject linking with certain types of hygiene stations 30 (e.g., antiseptic hand sanitizer dispensers, towelette dispensers, etc.). The rejected hygiene station may, for example, be of a type (e.g., an antiseptic hand sanitizer dispenser) that cannot provide an acceptable cleaning event for the selected patient associated with the breached patient zone (i.e., a patient with Clostridium difficile or some other condition).

In addition to patient zone controllers and hygiene stations, the systems described herein also preferably include one or more transient credentials 40 that can be used in connection with the other components of the system to monitor compliance with hygiene protocols. Each of the transient credentials 40 used in the systems, as described herein, may be associated with a selected transient object, e.g., a person or a piece of equipment that may move into and/or out of patient zones (i.e., is transient in the sense that it moves or can be moved). The transient credentials may preferably include, in various embodiments, an optional communication device capable of transmitting and/or receiving data and on-board memory that is operably connected to the communication device to store received data and/or transmit stored data as a part of the operation of the system. The operable connection between the on-board memory and the communication device may typically be performed by a controller that is also preferably resident on or in the transient credential. Examples of some potentially suitable controllers may include, e.g., an Application Specific Integrated Circuit (ASIC) state machine, a gate array, a microprocessor, a microcontroller, etc.

In some embodiments, the one or more transient credentials 40 may be associated with a health care worker or other person (e.g., visitor, janitorial staff, etc.) present within the health care facility in which the system 10 is used. The systems in which the transient credentials are used preferably include data associating a selected transient credential 40 with a selected person such that monitoring the compliance of that selected person with the hygiene protocols as described herein can be accomplished.

In some embodiments of the systems and methods described herein, one of the one or more transient credentials may be associated with a piece of equipment that, in a health care facility, is capable of moving relative to the patient zone controller 20. Examples of some types of equipment that may be associated with a transient credential may include, but is not limited to: stethoscopes, monitoring/diagnostic equipment (e.g., blood pressure monitors, blood oxygen monitors, cardiac monitors, etc.), intravenous equipment (e.g., IV stands, infusion pumps, etc.); etc. Associating a transient credential 40 with a selected piece of equipment in the systems described herein may be used for monitoring compliance with cleaning protocols for the selected pieces of equipment.

In some embodiments, the data associating the transient credential with a selected person or piece of equipment may be variable, i.e., may be changed as a part of the operation of the system by, for example, entering unique identification data when the transient credential is assigned to the selected person or piece of equipment. In other embodiments, the data associating the transient credential with a selected person or piece of equipment may be fixed, i.e., the transient credential may itself contain unique identifying data that is assigned to the selected person or piece of equipment when the transient credential is issued or otherwise associated with the selected person or piece of equipment.

Although generally described as being associated with a selected person or a piece of equipment, in some embodiments the same transient credential may be associated with multiple objects at the same time, e.g., one or more people and/or one or more pieces of equipment. In such a situation, the system would be configured to detect and associate a cleaning event for each of the associated people and/or pieces of equipment as a part of hygiene protocol compliance monitoring as discussed herein. Where the two different associated objects require different cleaning events, e.g., a person requires a hand cleaning event and a stethoscope requires an equipment cleaning event, the systems and/or methods may preferably be configured to detect that each of the different cleaning events takes place with entry of a transient credential into a patient zone and/or exit from a patient zone.

The data that assigns or associates a transient credential with a selected person or piece of equipment may be found in the patient zone controller 20, the hygiene station 30, and/or the transient credential 40. In a system that includes an optional central controller as described herein, the data indicative of assignment or association between a transient credential 40 and a selected person or piece of equipment may also or alternatively be found within the central controller in addition to or in place of the more local devices such as the patient zone controller 20, the hygiene station 30 and/or the transient credential 40.

The transient credentials used in systems as described herein may take a wide variety of forms. In some embodiments, the transient credentials 40 may be provided in the form of a badge, tag, label, display device, personal digital assistant (PDA), cell phone, pager, or any other article that is carried by or otherwise attached to the selected person or piece of equipment as they move into and out of patient zones in a health care facility in which the systems described herein are used.

Although some embodiments of the systems described herein may include as few as one patient zone controller 20, one hygiene station 30 linked to the patient zone controller 20, and one transient credential 40, in some embodiments, multiple patient zone controllers, hygiene station, and/or transient credentials may be used in the same health care facility (and, as noted herein, other embodiments of the systems and methods described herein may not include any patient zone controllers). In health care facilities that include multiple patient zone controllers, linked hygiene stations, and/or transient credentials 40, an optional central controller may be provided, with the different components potentially communicating with the central controller. Such communication may be one-way or two-way. For example, the central controller may be used to receive and/or gather hygiene compliance data from one or more of the patient zone controllers 20, hygiene stations 30, and/or transient credentials 40 in the system. In other systems, the central controller may also communicate data to one or more of the patient zone controllers, hygiene stations 30, and/or transient credentials 40 in the system as described herein.

One embodiment of a system 10A for monitoring hygiene protocol compliance is depicted in FIG. 1B. The system 10A as depicted in FIG. 1B includes two optional patient zone controllers 20, each of which defines a patient zone 22 as described herein. Each of the patient zone controllers 20 in the system 10A is linked to at least one hygiene station 30. The system 10A further includes multiple transient credentials 40 and an optional central controller 50. In addition to the hygiene stations 30 that are linked to one of the patient zone controllers 20, the system 10A optionally includes other hygiene stations 30 that are not linked to any particular patient zone controllers (although they may, in some embodiments, be linked to a patient zone controller). The system 10A further includes one or more transient credentials 40 that may be used in connection with the other components in the system 10A as described herein.

Although a specific number of the different components are depicted in connection with the system 10 of FIG. 1 and the system 10A of FIG. 1B, the systems described herein may include any suitable number of the various components. For example, although the system 10A includes two patient zone controllers 20, some embodiments of systems described herein may be implemented with as few as one patient zone controller 20 (as depicted in, e.g., FIG. 1) or three or more patient zone controllers. Further, the number of hygiene stations 30 may also vary, from as few as one hygiene station 30 to two or more hygiene stations. In addition, the number of transient credentials 40 provided within a system may vary from as few as one transient credential 40 (as depicted in, e.g., FIG. 1) to two or more transient credentials. Similarly, although a single central controller 50 is depicted in connection with system 10A, the central controller 50 may actually be embodied in a distributed manner such that multiple sub-central control units are networked together to provide a central controller function to the system 10A.

The optional central controller 50 may include, e.g., one or more data processing units capable of executing software and associated central memory, with the data processing unit(s) and software operating to store and/or retrieve data on central memory associated with the central controller 50. The central controller 50 may also preferably include a communication device capable of transmitting and/or receiving data from one or more other components within the system 10A that can be stored on the central memory of the central controller 50.

The optional central controller 50 may be operably connected with a variety of different components in the system 10A. In the embodiment depicted in FIG. 1B, the central controller 50 is depicted as operably connected to the patient zone controllers 20, the hygiene stations 30, and the transient credentials 40. In such a system, the central controller 50 may be capable of at least receiving data from the patient zone controllers 20, hygiene stations 30, and/or transient credentials 40 and may also be capable of transmitting data to the patient zone controllers 20, hygiene stations 30, and/or transient credentials 40.

In other embodiments, however, the systems described herein may not require such comprehensive communication schemes between a central controller 50 and the other components in the system. For example, it may be sufficient in some systems if the central controller 50 is in communication with, e.g., the patient zone controllers 20. In such a system, compliance information, i.e., compliance data obtained as a part of the monitoring of hygiene protocol compliance, can be shared with the central controller 50 through communication links between the central controller 50 and the patient zone controllers 20. Examples of some compliance data communicated to the central controller 50 may include, e.g., data indicative of cleaning events, transient credentials associated with cleaning events, entry into and/or exit out of patient zones, etc.

In another embodiment, the central controller 50 may be in communication with, e.g., the hygiene stations 30. In such a system, compliance information, i.e., compliance data obtained as a part of the monitoring of hygiene protocol compliance, can be shared with the central controller 50 through communication links between the central controller 50 and the hygiene stations 30. Examples of some compliance data communicated to the central controller 50 may include, e.g., data indicative of cleaning events, transient credentials associated with cleaning events, entry into and/or exit out of patient zones, etc.

In still other embodiments, the central controller 50 may be in communication with, e.g., the transient credentials 40. In such a system, compliance information, i.e., compliance data obtained as a part of the monitoring of hygiene protocol compliance, can be shared with the central controller 50 through communication links between the central controller 50 and the transient credentials 40. Examples of some compliance data communicated to the central controller 50 may include, e.g., data indicative of cleaning events, transient credentials associated with cleaning events, entry into and/or exit out of patient zones, etc.

In even further embodiments, the central controller 50 may be in communication with any combination of two or more groups of components, where the groups include, e.g., the patient zone controllers 20, the hygiene stations 30, and the transient credentials 40, etc.

With respect to the central controller 50, the communication links between the central controller 50 and the other components to which the central controller 50 is operably connected may be “real-time” such that data is communicated as it is obtained (and as can be reasonably accommodated on the communication links being used). In other systems, data (such as compliance data) may be communicated within the system in a batch mode where data may be accumulated in one or more components before being delivered to the central controller 50. For example, the compliance data stored on a patient zone controller 20, a hygiene station 30, and/or a transient credential 40 may be communicated to the central controller 50 at selected intervals such as, e.g., minutes, hours, days, number of events, etc. Still further, some systems may use a combination of both real-time and batch mode data transfer between the various system components.

In some embodiments, the compliance data may be accumulated between the associating of a component and its de-association (where the associating corresponds to the original association of a component with a patient, a health care worker, piece of equipment, etc. and the de-associating corresponds to the end of any such association). Such association and de-association activities may include the linking between a patient zone controller and hygiene station in the systems described herein. In some embodiments, compliance data may be accumulated over the course of a work shift or a portion of a work shift (in, e.g., the case of a health care worker or other health care facility personnel) or the data may be accumulated over the course of a patient visit if, e.g., a transient credential 40 is associated with a visitor to the health care facility.

Another optional feature provided in connection with the embodiment of depicted system 10A is that the hygiene station 30 linked to the patient zone controller 20 on the left side of FIG. 1B is located within the patient zone 22 defined by the patient zone controller 20. In contrast, the patient zone controller 20 located on the right side of FIG. 1B is linked to two different hygiene stations 30, with one of the linked hygiene stations 30 being located within the patient zone 22 defined by patient zone controller 20 and the other linked hygiene station 30 being located outside of the patient zone 22. Although the patient zone controller 20 on the right side is depicted as linked to two different hygiene stations 30, the patient zone controllers 20 of the systems described herein may, in some embodiments, be linked to more than two different hygiene stations 30 and those hygiene stations may, in various embodiments, be located within or outside of the patient zones of the patient zone controllers to which the hygiene stations are linked.

Although in some embodiments the hygiene station 30 linked to a patient zone controller 20 may not change, a patient zone controller 20 that moves within a health care facility may link with a variety of different hygiene stations 30 within the system. For example, if a selected patient associated with a patient zone controller 20 is moved from a patient room to undergo a procedure at another location (e.g., an MRI scan, etc.), the patient zone controller 20 may link with a hygiene station 30 positioned at the other location (in addition to its previously linked hygiene station or in place of its previously linked hygiene station). Any such changes in linking may, however, be subject to the acceptability of the hygiene station, i.e., its ability to provide the proper type of cleaning needed to satisfy the hygiene protocols in place for the patient zone.

Furthermore, as discussed herein, the system 10A may include a variety of different communication links with the various components in the system. In some embodiments, the communication links between the different components may be the same or different. For example, the communication links between the central controller 50 and the transient credentials 40 may be different than the communication links between the central controller 50 and the patient zone controllers 20 (e.g., the central controller 50 may communicate with the transient credentials 40 through a wireless connection while the central controller 50 may communicate with the patient zone controllers 20 through a hardware link, etc.).

In particular, the communication between a patient zone controller 20 and its linked hygiene station(s) 30 may be different than the communication links between the other components in the system. For example, the patient zone controller 20 to linked hygiene station 30 communication may be accomplished using a specific selected communication link that is, e.g., more robust than other communication links within the system.

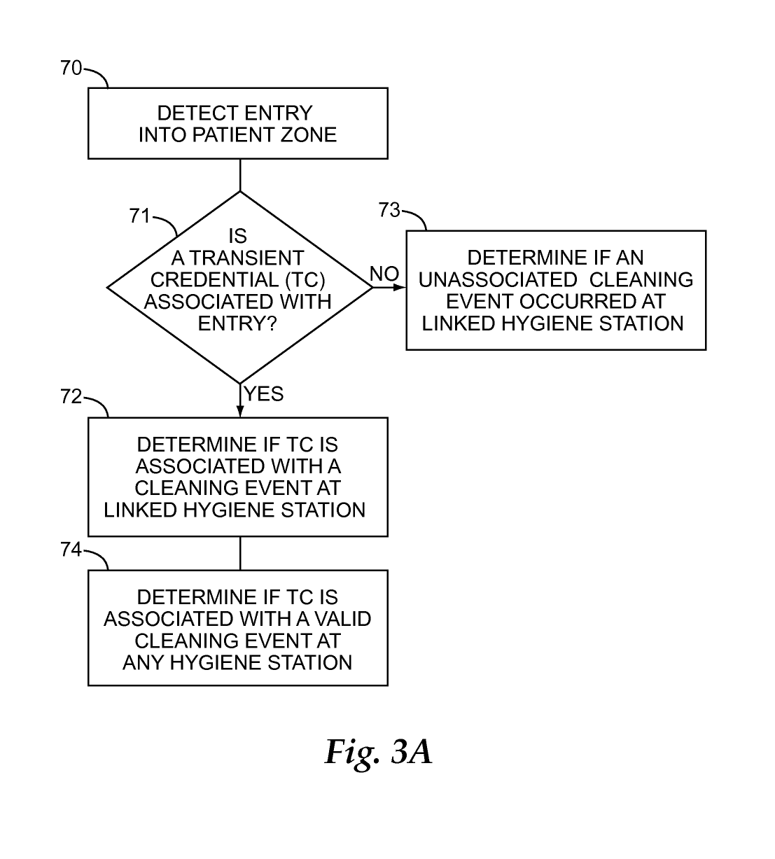

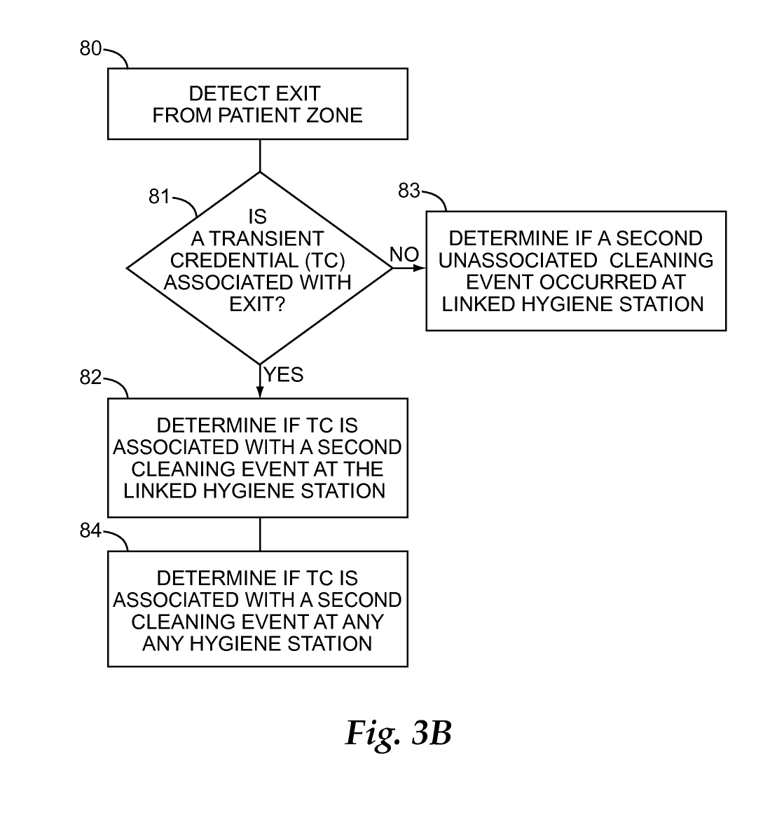

The systems described herein may be used to monitor compliance with hygiene protocols within a health care facility where hygiene protocols may include hand and/or equipment hygiene (i.e., whether hands and/or equipment are sanitized before entering the patient zone). Various aspects of the monitoring systems and methods and the configuration of various embodiments of the components that may be used to perform the monitoring are described in connection with FIGS. 2 and 3.

Referring to FIG. 2, the systems described herein may be configured to detect the occurrence of a cleaning event 60. The detection may be performed at a linked or unlinked hygiene station 30. As discussed herein, the hygiene station 30 itself may preferably be configured to detect the cleaning event. The system may further be configured to associate a transient credential 40 with the detected cleaning event 62 and store data identifying the transient credential 40 associated with the cleaning event. The data identifying the transient credential 40 associated with the cleaning event at the hygiene station 30 may be stored in one or more locations within the system 10. For example, the data may be stored in the patient zone controller 20 linked to the hygiene station 30 (if the cleaning event takes place at a linked hygiene station); in the transient credential 40 associated with the cleaning event (regardless of whether or not the hygiene station used is linked or unlinked); in the hygiene station 30 (where it may be communicated to a linked patient zone controller 20 if one exists); and/or in the central memory of a central controller 50 (regardless of whether or not the hygiene station used is linked or unlinked).

In some embodiments of the systems and methods described herein, the data identifying the transient credential 40 associated with the cleaning event at a hygiene station 30 may be stored locally in at least one of the patient zone controller 20, the hygiene station 30, and/or the transient credential 40. Local storage of the data identifying the transient credential 40 associated with the cleaning event at the hygiene station 30 may be useful in performing local monitoring of hygiene protocol compliance as discussed herein.

Referring to FIGS. 3A and 3B, the systems described herein may be configured to detect entry of a transient credential into a patient zone 70 and/or exit of a transient credential from a patient zone 80. In some embodiments, the entry and/or exit detection may be performed by the patient zone controller 20 and/or the transient credential 40 entering and/or exiting the patient zone depending on the technology used to perform the zone entry and/or exit detection. In some embodiments, the patient zone controller 20 may be configured to perform the zone entry and/or exit detection if, e.g., the technology used for entry and/or exit detection is a reflection technology such as RF reflection, LIDAR, optical reflection, acoustic reflection, etc.

In some embodiments, the transient credential 40 may be configured to perform the zone entry and/or exit detection if, e.g., the technology used for entry detection is a technology such as RFID where the transient credential 40 itself contains an RFID component configured to detect entry and/or exit of the transient credential 40 into and/or from a RF field generated by, e.g., the patient zone controller 20. In still other embodiments, the transient credential 40 may contain an ultrasonic and/or infrared energy detector configured to detect entry and/or exit of the transient credential 40 into and/or from a field of ultrasonic and/or infrared energy generated by, e.g., the patient zone controller 20. These examples are not meant to be exhaustive and any suitable technology and configuration of components contained in the patient zone controller 20 and/or transient credential 40 may be used to detect entry and/or exit of the transient credential 40 into and/or out of a patient zone.

FIGS. 3A and 3B depict configurations of the systems and methods described herein for the detection of patient zone entries and association of cleaning events with patient zone entries (FIG. 3A) and the detection of patient zone exits and association of cleaning events with patient zone exits (FIG. 3B). It should be understood that not all systems and methods described herein may be configured to detect both patient zone entries and exits. In some embodiments, the systems and methods described herein may be configured to detect only patient zone entries or only patient zone exits. In some further embodiments, each patient zone controller may be independently configurable to detect patient zone entry and/or exit based on a variety of factors as discussed herein.

Referring to FIG. 3A, when an entry into a patient zone is detected 70, the systems and/or methods described herein are preferably configured to make a determination as to whether or not the entry into the patient zone is associated with a transient credential 71. If the zone entry is associated with a transient credential, then the system is configured to make a determination as to whether or not the transient credential detected as entering the patient zone is associated with a cleaning event at a linked hygiene station 72. That determination may preferably include a determination that the cleaning event at the linked hygiene station was performed within a selected time period. The selected time period may include time before entry of the transient credential 40 into the patient zone and/or time after entry of the transient credential 40 into the patient zone. For example, in some systems, the time period may include a selected period of time after entry into the patient zone if the linked hygiene station 30 is located within the patient zone 22 (thus requiring entry into the patient zone to reach the hygiene station 30). In other examples in which the linked hygiene station 30 is located outside of the patient zone, the selected time period may be limited to the period of time before entry of the transient credential 40 in the patient zone.

The system may, in some embodiments, be further configured to store compliance data that is indicative of the determination that the transient credential 40 detected as entering the patient zone 22 either is or is not associated with a cleaning event at the linked hygiene station 30 within the selected time period. The compliance data may be stored at one or more of the patient zone controller 20, the linked hygiene station 30, the transient credential 40, and/or the central controller 50.

If it is determined that the transient credential detected as entering the patient zone 70 is not associated with a cleaning event at a linked hygiene station (optionally within the selected time period) 72, the system may be configured to make a determination as to whether or not the transient credential detected as entering the patient zone is associated with a cleaning event (optionally within a selected period of time) at a hygiene station that is not linked to the patient zone controller defining the entered patient zone 74.

In such a situation, the transient credential 40 may be considered as “clean” for the purposes of compliance data generation. In other words, the person or piece of equipment associated with the detected transient credential that exited the patient zone may potentially be associated with a second cleaning event at an unlinked hygiene station before entering the patient zone to avoid generating data indicative of a non-compliant event in the systems described herein.

In such a situation, i.e., where the cleaning event associated with a transient credential occurs at an unlinked hygiene station, the system may be configured to determine whether or not the transient credential 40 is associated with another non-compliant event such as, e.g., entry into a different patient zone, etc. between the time of the cleaning event at the unlinked hygiene station and entry into the breached patient zone.

For cleaning events performed at unlinked hygiene stations, the system may further be configured to make a determination as to whether the associated cleaning event at the unlinked hygiene station is a valid cleaning event 74 based on the hygiene protocols in effect for the patient zone that was entered. For some patient zones, only certain types of cleaning events may be considered valid (or, conversely, some types of cleaning events may be considered invalid). For example, the unlinked hygiene station may be of a type (e.g., an antiseptic hand sanitizer dispenser) that cannot provide an acceptable cleaning event for the selected patient associated with the breached patient zone (i.e., a patient with Clostridium difficile or some other condition).

If it is determined that the transient credential 40 detected as entering the patient zone 22 is not associated with a cleaning event at the linked hygiene station 30 (or an unlinked hygiene station as discussed herein), then the system may be configured to provide an alert indicating a non-compliant or potentially non-compliant event with respect to the hygiene protocols in place in the breached patient zone to provide an opportunity for remedial action to avoid a final determination that a non-compliant event has occurred.

Such alerts may be provided using the patient zone controller 20, the hygiene station 30, the transient credential 40, and/or the central controller 50. The alert may take any suitable form, e.g., visible, audible, tactile, etc. Examples of some alerts may be found in, e.g., U.S. Patent Application Publication No. US 2008/0246599 (Hufton et al.); U.S. Pat. No. 6,975,231 (Lane et al.); U.S. Pat. No. 6,882,278 (Winings et al.); U.S. Pat. No. 6,727,818 (Wildman et al.); U.S. Pat. No. 6,426,701 (Levy et al.); U.S. Pat. No. 5,952,924 (Evans et al.); U.S. Pat. No. 5,202,666 (Knippscheer); U.S. Pat. No. 4,896,144 (Bogstad); etc. In still other embodiments, alerts and/or feedback may be provided using devices that are not a part of the system, i.e., one or more devices other than the patient zone controllers, hygiene stations, transient credentials, and optional system controllers described herein. Some potentially suitable examples may include, e.g., alerts provided by a display device, personal digital assistant (PDA), cell phone, pager, etc.

Another potential situation is also depicted in FIG. 3A in that, although a zone entry may be detected 70, the system and/or method may not be able to associate the patient zone entry with a transient credential for a variety of reasons, e.g., the transient credential was obscured or shielded from a detector, lack of power (e.g., dead battery), the object entering the patient zone does not have a transient credential, etc.

In such a situation, i.e., detection of a patient zone entry 70 with no transient credential associated with the zone entry, the system and/or method may be configured to determine whether a cleaning event has occurred at a linked hygiene station that is also not associated with any transient credential 73. This determination may be limited by, e.g., a selected time period to provide increased assurance that the otherwise unassociated cleaning event and the unassociated patient zone entry can be paired with each other. For example, the unassociated cleaning event at the linked hygiene station may need to have occurred within 5 minutes or less, 1 minute or less, 30 seconds or less, etc. of the detected patient zone entry that also is not associated with a transient credential.

Referring to FIG. 3B, when an exit from a patient zone is detected 80, the systems and/or methods described herein are preferably configured to make a determination as to whether or not the exit from the patient zone is associated with a transient credential 81. If the zone exit is associated with a transient credential, then the system is configured to make a determination as to whether or not the transient credential detected as exiting the patient zone is associated with a second cleaning event at a linked hygiene station 82. That determination may preferably include a determination that the cleaning event at the linked hygiene station was performed within a selected time period. The selected time period may include time before exit of the transient credential 40 from the patient zone 22 and/or time after exit of the transient credential 40 from the patient zone 22. For example, in some systems, the time period may include a selected period of time before exit from the patient zone 22 if the linked hygiene station 30 is located within the patient zone 22 (thus requiring use of the hygiene station 30 before exiting from the patient zone 22). In other examples in which the linked hygiene station 30 is located outside of the patient zone 22, the selected time period may be limited to the period of time after exit of the transient credential 40 from the patient zone 22.

The system may, in some embodiments, be further configured to store compliance data that is indicative of the determination that the transient credential 40 detected as exiting the patient zone 22 either is or is not associated with a cleaning event at the linked hygiene station 30 within the selected time period. The compliance data may be stored at one or more of the patient zone controller 20, the linked hygiene station 30, the transient credential 40, and/or the central controller 50.

If it is determined that the transient credential detected as exiting the patient zone 80 is not associated with a second cleaning event at a linked hygiene station (optionally within the selected time period) 82, the system may be configured to make a determination as to whether or not the transient credential detected as exiting the patient zone is associated with a cleaning event (optionally within a selected period of time) at a hygiene station that is not linked to the patient zone controller defining the exited patient zone 84.

In such a situation, the transient credential 40 may be considered as “clean” for the purposes of compliance data generation. In other words, the person or piece of equipment associated with the detected transient credential that entered the patient zone may potentially be associated with a cleaning event at an unlinked hygiene station after exiting the patient zone to avoid generating data indicative of a non-compliant event in the systems described herein.

In such a situation, i.e., where the cleaning event associated with a transient credential occurs at an unlinked hygiene station, the system may be configured to determine whether or not the transient credential 40 is associated with another non-compliant event such as, e.g., entry into a different patient zone, etc. between the time of the cleaning event at the unlinked hygiene station and exit from the patient zone.

For cleaning events performed at unlinked hygiene stations, the system may further be configured to make a determination as to whether the associated cleaning event at the unlinked hygiene station is a valid cleaning event 84 based on the hygiene protocols in effect for the patient zone that was exited. For some patient zones, only certain types of cleaning events may be considered valid (or, conversely, some types of cleaning events may be considered invalid). For example, the unlinked hygiene station may be of a type (e.g., an antiseptic hand sanitizer dispenser) that cannot provide an acceptable cleaning event for the selected patient associated with the exited patient zone (i.e., a patient with C-Diff, or some other condition).

If it is determined that the transient credential 40 detected as exiting the patient zone 22 is not associated with a cleaning event at the linked hygiene station 30 (or an unlinked hygiene station as discussed herein), then the system may be configured to provide an alert indicating a non-compliant or potentially non-compliant event with respect to the hygiene protocols in place for the exited breached patient zone to provide an opportunity for remedial action to avoid a final determination that a non-compliant event has occurred. Such alerts may be provided as discussed above with respect to patient zone entries.

Another potential situation is also depicted in FIG. 3B in that, although a patient zone exit may be detected 80, the system and/or method may not be able to associate the patient zone exit with a transient credential for a variety of reasons, e.g., the transient credential was obscured or shielded from a detector, lack of power (e.g., dead battery), the object exiting the patient zone does not have a transient credential, etc.

In such a situation, i.e., detection of a patient zone exit 80 with no transient credential associated with the zone exit, the system and/or method may be configured to determine whether a second cleaning event has occurred at a linked hygiene station that is also not associated with any transient credential 83. This determination may be limited by, e.g., a selected time period to provide increased assurance that the otherwise unassociated cleaning event and the unassociated patient zone exit can be paired with each other. For example, the unassociated cleaning event at the linked hygiene station may need to have occurred within 5 minutes or less, 1 minute or less, 30 seconds or less, etc. of the detected patient zone exit that also is not associated with a transient credential.

As discussed herein, the patient zone controllers are configured to define a patient zone as a part of the monitoring of compliance with hygiene protocols in place for the patient zone. Although, in some embodiments, it may be sufficient that the patient zone controller defines a single patient zone, in other embodiments, it may be useful to provide a patient zone controller that is configured to define two or more different patient zones. Referring to FIG. 4, one embodiment of a depicted patient zone controller 120 is configured to define two different patient zones 122a and 122b. Although depicted in two dimensions, in many embodiments, the patient zones may, in some embodiments, occupy a three-dimensional volume.

Also, although the two different patient zones 122a and 122b are depicted as differing from each other in terms of size, they may be different in any of a number of different characteristics such as, e.g., the technology used to define the zone (e.g., optical versus acoustic, etc.), shape, etc. For example, patient zone 122a may be defined using, e.g., LIDAR technology, while patient zone 122b may be defined using, e.g., RFID technology. If the different patient zones are defined using different technologies, the patient zones may be described as being multi-modal (i.e., operating using different modes of detection, e.g., optics, acoustics, etc.). In other embodiments, the different patient zones may be defined using the same technology that is differentiated in some way, e.g., frequency, signal strength, etc.

In some embodiments in which two or more different patient zones are defined for a selected patient, the different patient zones may be defined by the same patient zone controller 120 as depicted in FIG. 4, while in other embodiments, multiple patient zone controllers may be associated with the same selected patient, with each of the patient zone controllers providing one or more different patient zones.

In some embodiments, the different patient zones 122a and 122b may be defined at the same time and used to detect entry and/or exit events at the same time. In other embodiments, the patient zone controller may be configured to allow selection of one of the patient zones, while deactivating the other patient zone or not activating any other patient zones. In those embodiments in which two or more different patient zones are activated at the same time, the system may be described as being multi-zonal. In those embodiments in which two or more different patient zones differ in terms of size or shape, the patient zones may be described as multi-tiered.

In a multi-tiered patient zone situation such as, e.g., that depicted in FIG. 4, the system may be configured such that the larger zone 122b is used to detect the approach to and/or exit from the inner zone 122a of a transient credential and determine whether or not the person or piece of equipment associated with the detected transient credential is associated with a valid cleaning event as discussed herein. The smaller patient zone 122a may be used to determine compliance with the hygiene protocols in place for the selected patient If no association with a valid cleaning event is found in the system for the transient credential detected entering and/or exiting the larger patient zone 122b, an alert or other indication may be provided (e.g., to the transient credential) so that a valid cleaning event can be performed with respect to the detected transient credential before the transient credential enters the smaller patient zone 122a where it could generate a non-compliant event with respect to the hygiene protocols in place.

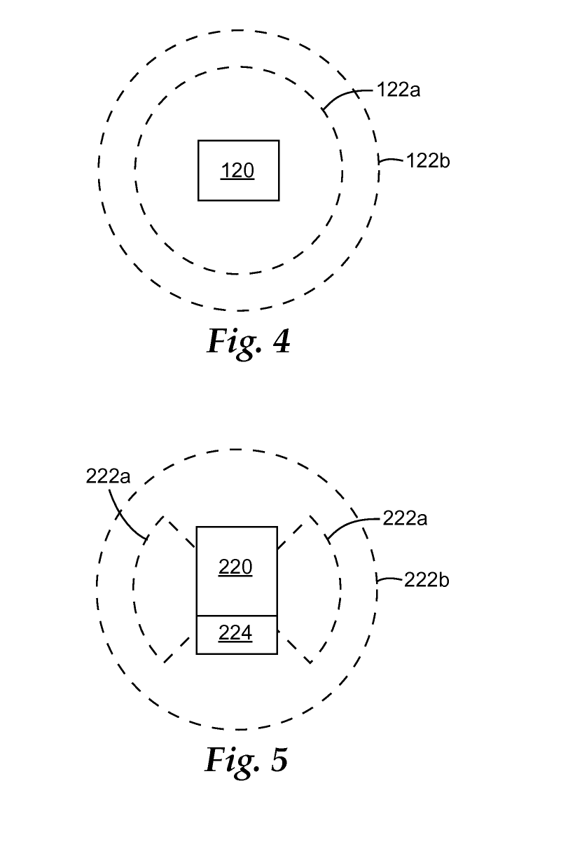

Referring to FIG. 5, one embodiment of a patient zone controller 220 is depicted along with patient zones 222a and 222b. The patient zones depicted in FIG. 5 are examples of patient zones that differ from each other in terms of size and shape. The smaller patient zone 222a can be characterized as including two arcuate projections and may be, for example, well-suited to a system in which the patient zone 222a is developed to protect a patient in a bed (where entry to the patient will typically occur from the sides of the bed as compared to the head or the foot).

Another optional feature of the systems and methods described herein that is depicted in FIG. 5 is the inclusion of a motion indicator 224 that can be used to control the activation and/or deactivation of the different patient zones. For example, one of the criteria that may be used to select one or more patient zones for activation/deactivation is whether the selected patient associated with the patient zone controller 220 is in transit within a health care facility. The motion indicator 224 may be in the form of a motion sensor (e.g., accelerometer, etc.) that detects motion associated with movement of the patient between two different locations. The motion indicator 224 may, in some embodiments, be in the form of a switch or other device that can be activated within or on the patient zone controller 220 to indicate that the patient is in transit. In still other embodiments in which a central controller is used, the central controller may communicate with the patient zone controller 220 to selectively activate/deactivate patient zones as appropriate.

During movement, the patient zone or zones may be selected by the patient zone controller 220, central controller, etc. to reduce the likelihood of identification of non-compliant events by, e.g., activating smaller patient zones, reducing the size of a patient zone, patient zones with different shapes, activating patient zones operating on different modalities (technologies), etc.

As discussed herein, the systems and methods described herein may also be configured to allow for the selection of the patient zones to be defined by the patient zone controllers. The selection of the patient zones may be based on a variety of one or more different factors. The factors may be associated with the selected patient associated with the patient zone controller defining the patient zone or zones. Examples of some potentially useful patient-based criteria may include, for example, the health of the patient, the type of illness or condition from which the patient suffers, etc. Selection of patient zones to be defined by the patient zone controllers may also or alternatively be based on what may be considered “environmental” factors that are not necessarily associated with the selected patient such as, e.g., whether the patient is moving through the facility, the type of health care facility in which the patient is located, the time of day, day of the week, time of year, outbreaks of contagious illnesses in the health care facility itself and/or in the community in which the health care facility is located, etc.

In still other variations, the patient zones defined by the patient zone controllers may be based on still other factors such as, e.g., the historical hygiene protocol compliance rate for a selected transient credential. For example, health care facilities (or portions of health care facilities, e.g., wards, departments, etc.) that have a historically low hygiene protocol compliance rate may be subject to a different set of patient zones, alerts, reminders, etc. that are designed to improve the compliance rate over time. In some instances, the selection of a particular patient zone may be based on the historical compliance rate for a particular transient credential (or a particular group of transient credentials). For example, the transient credentials associated with visitors to a health care facility may be subjected to a set of patient zones, alerts, reminders, etc. that are different than those applied to other transient credentials.

The selection of patient zones defined by a patient zone controller may be accomplished within the patient zone controller itself or be driven by one or more devices external from the patient zone controller. In some embodiments, the patient zone selection may be accomplished locally, i.e., at the patient zone controller itself using any suitable technique, e.g., keypad, touch screens, switches, buttons, knobs, voice commands, etc. In other embodiments, the selection process may be performed using an external device such as a dedicated programming device, personal digital assistant (PDA), cell phone, etc. In still other embodiments, the patient zone(s) defined by a patient zone controller may be variable based on, e.g., the transient credential detected as entering or exiting the patient zone (with the selection thus typically occurring automatically within the patient zone controller). In some embodiments in which a patient zone controller is connected to an optional central controller, the patient zone selection may be accomplished by communication between the central controller and the patient zone controller, e.g., the central controller may drive the selection of the patient zone(s) to be defined by the patient zone controller based on any of a number of factors (such as those described herein).

The systems and methods for monitoring hygiene protocol compliance as described herein may, in some embodiments, be configured to allow for selection/modification of the hygiene protocol(s) to be applied to patient zone entries and/or exits that take place in the system.

Selection of the hygiene protocol(s) to be applied within any particular patient zone may be based on a variety of one or more different factors. The factors used may be associated with the selected patient associated with the patient zone controller defining the patient zone or zones. Examples of some potentially useful patient-based criteria may include, for example, the health of the patient, the type of illness or condition from which the patient suffers, whether the patient is moving through the facility, etc. Selection of hygiene protocols may also or alternatively be based on what may be considered “environmental” factors that are not necessarily associated with the selected patient such as, e.g., the type of health care facility in which the patient zone is located, the time of day, the day of the week, the time of year, the existence of an outbreak of contagious illness near the patient zone; and the existence of an outbreak of contagious illnesses in the community in which the patient zone is located, etc.

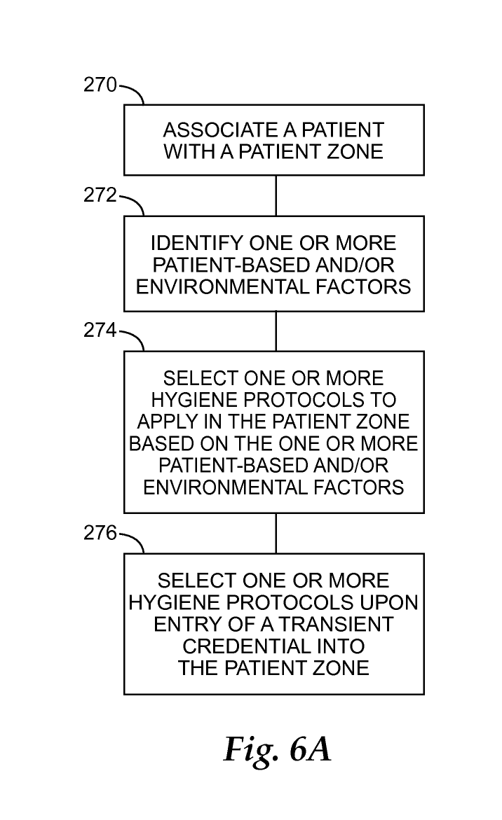

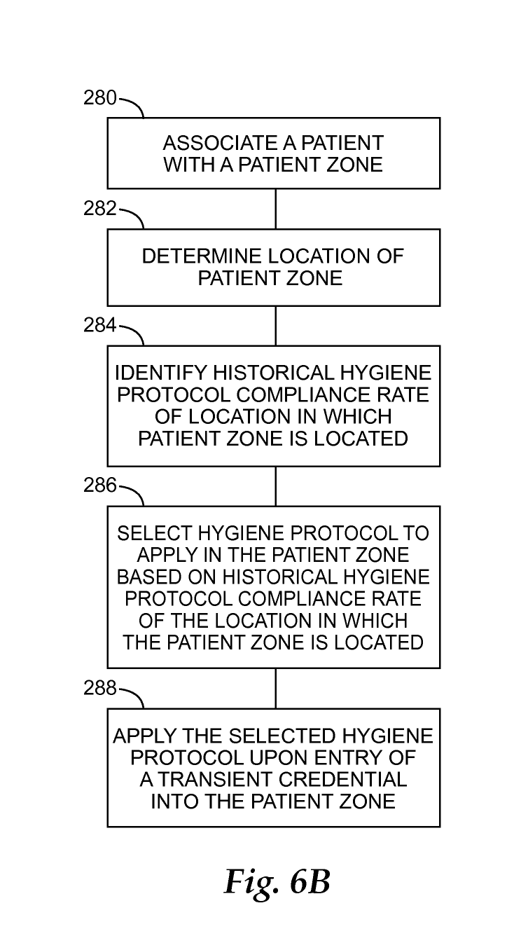

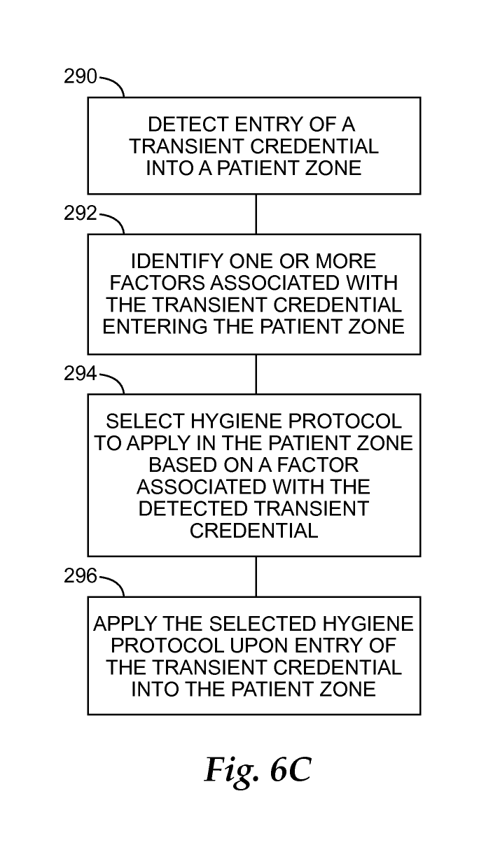

FIG. 6A depicts one exemplary embodiment of a method in which one or more hygiene protocols are selected and applied within a patient zone based on one or more patient-based and/or environmental factors. Such methods may include, for example. associating a selected patient with a patient zone 270 (as, e.g., described herein). One or more of the patient-based and/or environmental factors discussed herein may be identified 272. For example, the selected patient may have an illness that requires a health care worker to wash with soap and water rather than a waterless hand sanitizer, etc. As another example, an environmental factor such as the occurrence of a highly contagious illness may be indicated in the facility in which the patient zone is located, etc. The method may further include selecting one or more hygiene protocols to apply in the patient zone based on the one or more patient-based and/or environmental factors 274. With the one or more hygiene protocols selected, the method may further include applying a selected hygiene protocol upon entry of a transient credential into the patient zone 276.

In other methods, the hygiene protocols applied within a particular patient zone may be based on still other factors such as, e.g., the historical hygiene protocol compliance rate associated with a location and/or a selected transient credential. For example, health care facilities (or portions of health care facilities, e.g., wards, departments, etc.) that have a historically low hygiene protocol compliance rate may be subject to a different set of rules, alerts, reminders, etc. that are designed to improve the compliance rate over time.

FIG. 6B depicts an exemplary embodiment of a method in which one or more hygiene protocols are selected and applied within a patient zone based on historical hygiene protocol compliance associated with a location. Such methods may include, for example. associating a selected patient with a patient zone 280 (as, e.g., described herein). Optionally, the location of the patient zone may be identified 282. For example, the patient zone may be located in a particular ward or unit within a larger health care facility in which hygiene is a greater or lesser concern. The historical hygiene protocol compliance rate of the location in which the patient zone is located may be identified or determined 284. The method may further include selecting one or more hygiene protocols to apply in the patient zone based on the historical hygiene protocol compliance rate of the location in which the patent zone is located 286. For example, if the patient zone is located in an area that has a historically low hygiene protocol compliance rate, the hygiene protocol(s) selected may involve more assertive alerts, reminders, etc. in an attempt to raise the hygiene protocol compliance rate associated with that location. With the one or more hygiene protocols selected, the method may further include applying a selected hygiene protocol upon entry of a transient credential into the patient zone 288.

In still other methods, the selection of a particular hygiene compliance protocol for a selected patient zone may be based on one or more factors associated with a transient credential. In one example, the factor associated with the transient credential may be the historical compliance rate for a particular transient credential, a particular group of transient credentials to which the entering transient credential belongs, etc. Based on the factor(s) associated with the entering transient credential, a hygiene protocol may be selected such that, e.g., the transient credentials associated with visitors to a health care facility may be subjected to a set of hygiene protocols, alerts, reminders, etc. that are different than those applied to other transient credentials entering the patient zones.

FIG. 6C depicts an exemplary embodiment of a method in which one or more hygiene protocols are selected and applied within a patient zone based on one or more factors associated with the entering transient credential. Such methods may include, for example, detecting entry of a transient credential into a patient zone 290 (as, e.g., described herein). One or more factors associated with the transient credential entering the patient zone may be identified 292 (e.g., the specific identity of an individual associated with the transient credential, a group to which the transient credential belongs (e.g., visitors, nurses, doctors, etc.), etc. The method may further include selecting one or more hygiene protocols to apply in the patient zone to entry of the transient credential based on the one or more factors associated with the entering transient credential 294. With the one or more hygiene protocols selected, the method may further include applying the selected hygiene protocol upon entry of a transient credential into the patient zone 296.

Although different methods of selecting hygiene protocols to apply within a patient zone are described herein in connection with FIGS. 6A-6C, the hygiene protocol selection process may involve two or more of the methods discussed. For example, the hygiene selection protocol may involve factors associated with the patient and/or environment (as discussed, e.g., in connection with FIG. 6A) and one or more factors associated with the transient credential entering the patient zone (as discussed, e.g., in connection with FIG. 6B). Many other variations may also be used.

The selection of one or more hygiene protocols to be applied within a patient zone may be accomplished within the patient zone controller itself or be driven by one or more devices external from the patient zone controller. In some embodiments, the hygiene protocol selection may be accomplished locally, i.e., at the patient zone controller itself using any suitable technique, e.g., keypad, touch screens, switches, buttons, knobs, voice commands, etc. In other embodiments, the selection process may be performed using an external device such as a dedicated programming device, personal digital assistant (PDA), cell phone, etc. In still other embodiments, the hygiene protocol(s) selected for the patient zone may be variable based on, e.g., the transient credential detected as entering or exiting the patient zone (with the selection thus typically occurring automatically within the patient zone controller). In some embodiments in which a patient zone controller is connected to an optional central controller, the hygiene protocol selection may be accomplished by communication between the central controller and the patient zone controller, e.g., the central controller may drive the selection of the hygiene protocol(s) to be applied within the patient zone based on any of a number of factors (such as those described herein).

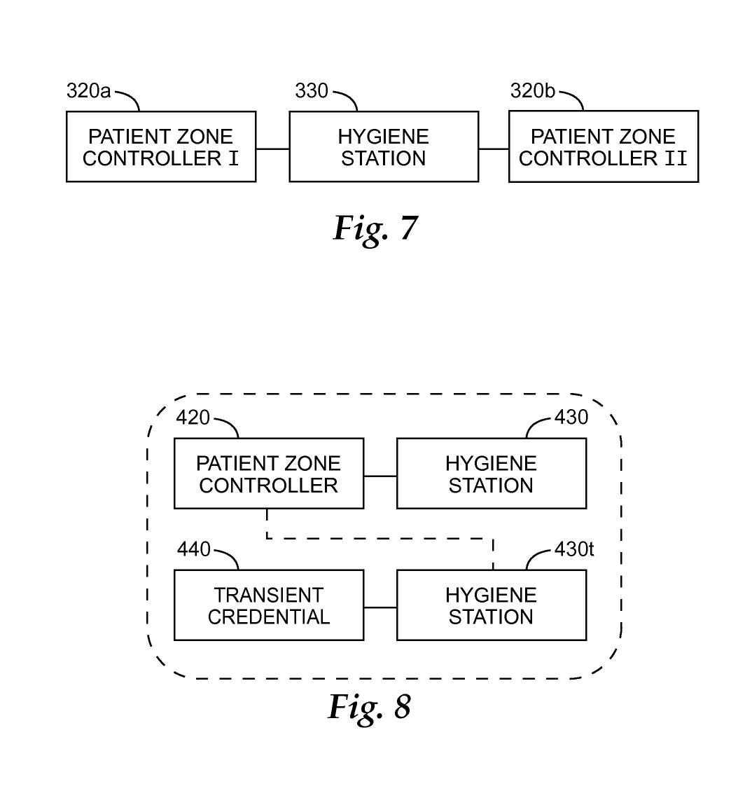

FIG. 7 depicts another feature that may form a part of some embodiments of systems as described herein. The feature depicted in connection with FIG. 7 is that two different patient zone controllers 320a and 320b may be linked to the same hygiene station 330. Linking of more than one patient zone controller to the same hygiene station may be useful in, for example, hospital wards where multiple patients are located in the a relatively small area such that the use of a common hygiene station 330 may be acceptable. Patient zone control over entry detection and compliance monitoring would typically be performed by each of the patient zone controllers 320a and 320b independently of each other.

Another optional feature depicted in connection with FIG. 8 is the temporary linking of a hygiene station 430t with a patient zone controller 420 that defines a patient zone. In the embodiment depicted in FIG. 8, the patient zone controller 420 is also linked with a hygiene station 430, although the linked hygiene station 430 may be optional in some embodiments. The hygiene station 430t that is temporarily linked to the patient zone controller 420 may also be associated with the transient credential 440.

One example of an embodiment in which this configuration may be used is in the case of a portable hygiene station 430t such as a wearable antiseptic hand sanitizer dispenser or other hygiene station designed to be carried or transported on the person or piece of equipment associated with the transient credential 440. As, for example, a health care worker associated with the transient credential 440 approaches a patient zone controller 420, the hygiene station 430t travelling with the transient credential 440 may establish a link to the patient zone controller 420 such that cleaning events performed using the hygiene station 430t can be registered locally because the hygiene station 430t is a linked hygiene station for the purposes of the systems and methods described herein. If the hygiene station 430 is also present, the use of that hygiene station or the hygiene station 430t may be used to comply with the hygiene protocols applied within the health care facility.

The above discussion includes hygiene stations that include components that are capable of determining the occurrence of a cleaning event and, preferably, capable of transmitting data associated with a detected cleaning event by any suitable technology. In some systems, however, it may be desirable to provide the ability to retrofit existing hygiene apparatus with cleaning event detectors that can provide the cleaning event detection and, optionally, the communication capabilities that allow the existing hygiene apparatus to function as a hygiene station in the systems and methods of hygiene protocol compliance described herein. The following discussion will describe systems and methods of retrofitting one or more hygiene apparatus with a cleaning event detector to provide the functionality needed to convert the existing hygiene apparatus into a hygiene station.

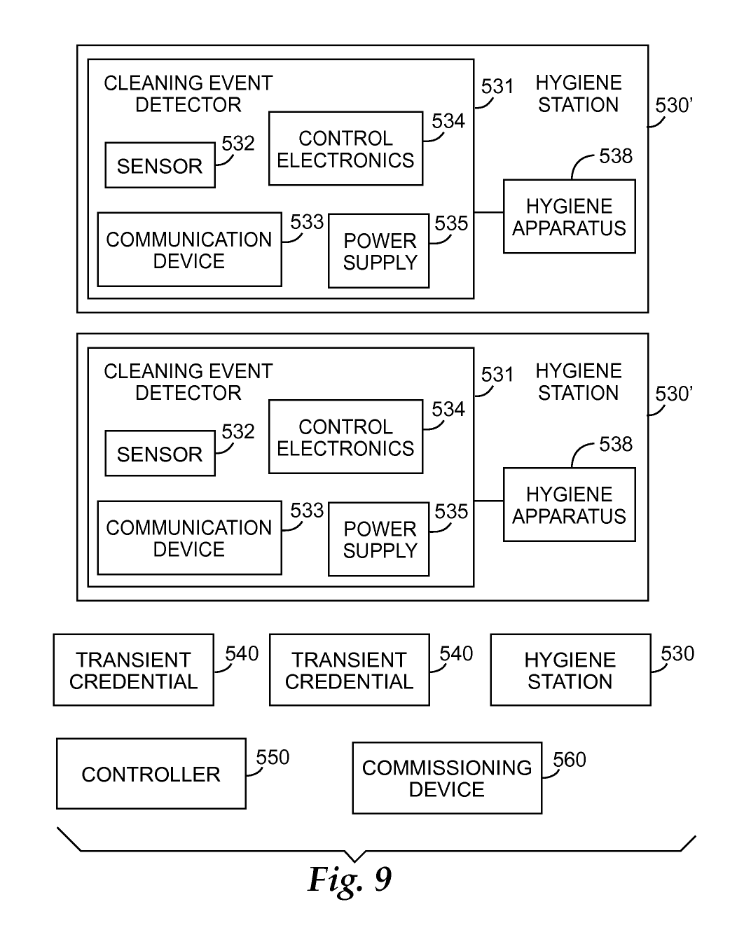

FIG. 9 depicts one embodiment of a system 510 for monitoring hygiene protocol compliance. The system 510 as depicted in FIG. 9 includes a variety of components, some of which may be optional in any given hygiene monitoring system. Among the components depicted in the system 510 of FIG. 9 are hygiene stations 530 (with integral components for detecting cleaning events as described herein), retrofitted hygiene stations 530′, transient credentials 540, a controller 550, and a commissioning device 560.

The retrofitted hygiene stations 530′ as described herein include a cleaning event detector 531 associated with a hygiene apparatus 538, with the cleaning event detector 531 configured to detect the occurrence of a cleaning event at the associated hygiene apparatus 538. As discussed herein, retrofitting of an existing hygiene apparatus 538 that does not have cleaning event detection capabilities with a cleaning event detector 531 can potentially offer the opportunity to incorporate existing hygiene infrastructure in a health care facility into a hygiene protocol monitoring system.

The hygiene apparatus that may be retrofitted with a cleaning event detector to provide a retrofitted hygiene station as described herein may include virtually any type of apparatus that functions to improve hygiene within a health care facility. Examples of some suitable hygiene apparatus that can be used to improve the hygiene of the hands of a health care worker, visitor, patient, etc. may include, e.g., soap dispensers, sinks (in combination, e.g., with soap dispensers), antiseptic hand sanitizer dispensers, towelette dispensers (where the towelettes preferably include some form of suitable antiseptic cleanser), glove dispensers, UV disinfectant stations, etc. In the case of hand hygiene, a cleaning event can be described as, e.g., a technique that can be used to provide a person with sanitary hands through, e.g., washing, the use of sanitizing materials/techniques, covering the hands using sterile gloves, etc. In some embodiments, the hygiene apparatus used in the systems and methods described herein may be used to or be capable of cleaning equipment such as, e.g., stethoscopes, monitoring/diagnostic equipment (e.g., blood pressure monitors, blood oxygen monitors, cardiac monitors, etc.), intravenous equipment (e.g., IV stands, infusion pumps, etc.); etc. As used in connection with equipment, a cleaning event can be described as, e.g., a technique that can be used to sanitize appropriate portions of the equipment (e.g., the portions of a stethoscope that contact a patient or the hands of a user of the stethoscope, etc.).

The cleaning event detectors 531 to be associated with the hygiene apparatus 538 in the systems described herein may take a variety of different forms, with the specific form of the cleaning event detector 531 typically being selected based on the type of hygiene apparatus 538 with which the cleaning event detector 531 is to be associated. The cleaning event detector 531 typically will include a sensor 532 that is operable to detect a cleaning event performed at the associated hygiene apparatus 538.

In addition to the sensor 532, the cleaning event detectors 531 as described herein may preferably include, in various embodiments, a communication device 533, control electronics 534, and a power supply 535 that are operably connected to each other and/or the sensor 532 such that the cleaning event detector 531 can detect the occurrence of a cleaning event at the associated hygiene apparatus 538 and provide data regarding that cleaning event to a patient zone controller and/or central system controller as described herein.

The communication device 533 may be in the form of a transceiver capable of transmitting data to and receiving data from devices outside of the cleaning event detector 531 (such as, e.g., a patient zone controller, central system controller, etc.). In other embodiments, the communication device 533 provided in the cleaning event detector 531 may be in the form of a transmitter that is used only to communicate data obtained using the sensor 532 to a device outside of the cleaning event detector 531.

The control electronics 534 provided as a part of the cleaning event detector 531 may include on-board memory and a processor, with the control electronics 534 being operably connected to the sensor 532 and the communication device 533 to receive data from the sensor, potentially analyze that data, and communicate with the communication device 533 to transmit and/or receive data. Examples of some potentially suitable processors used in the control electronics 534 may include, e.g., an Application Specific Integrated Circuit (ASIC) state machine, a gate array, a microprocessor, a microcontroller, etc. The on-board memory may be in the form of any suitable memory device, e.g., flash memory, etc.

In addition to the sensor 532, communication device 533, and control electronics 534, the cleaning event detector 531 may also preferably include a power supply 535 that is operably connected to the various components in the cleaning event detector 531 that require power to operate. For example, the power supply 535 may be operably connected to the sensor 532, communication device 533, and/or control electronics to provide the functionality described herein. The power supply 535 may be provided in any suitable form, although it may be preferred that the power supply 535 be self-contained such that the cleaning event detector 531 may be capable of stand-alone operation, i.e., that the cleaning event detector 531 need not be connected to an external source of power. Examples of some potentially suitable self-contained power supplies may include, e.g., batteries, capacitors, fuel cells, solar cells, etc.

The systems described herein may further be configured to associate a transient credential 540 with a detected cleaning event at the hygiene apparatus 538 associated with the cleaning event detectors 531 (e.g., as described above in connection with hygiene stations 30 and transient credentials 40). The association of a transient credential 540 with a cleaning event occurring at a hygiene apparatus 538 associated with a cleaning event detector 531 may, in some embodiments, require that the cleaning event detector 531 (e.g., its control electronics 534 and/or communication device 533) be configured to and capable of identifying a transient credential 540 that is proximate (or otherwise associated with) the hygiene apparatus 538 during a cleaning event that is detected by the cleaning event detector 531. In other embodiments, the transient credential 540 may be configured as described herein to detect the proximity of a hygiene station 530′ (or 530) and to receive data from the cleaning event detector 531 (or the hygiene station 530) that a cleaning event has occurred that should be associated with the transient credential 540.

Data identifying or associating a transient credential 540 with a cleaning event at any of the hygiene stations 530, 530′ may be stored in one or more locations within the system 510. For example, the data may be stored in a controller 550; in the transient credential 540 associated with the cleaning event; in the hygiene station 530, 530; and/or in a patient zone controller (if the system includes a patient zone controller as described herein).

In some embodiments of the systems and methods described herein, the data identifying the transient credential 40 associated with the cleaning event at the linked hygiene station 30 may be stored locally in at least one of a patient zone controller (if present), the hygiene station 530, 530′ used to perform the cleaning event, and/or the transient credential 540. Local storage of the data identifying the transient credential 540 associated with a cleaning event at the hygiene station 530, 530′ used to perform the cleaning event may be useful in performing local monitoring of hygiene protocol compliance as discussed herein.

Although the cleaning event detectors 531 may be described as having a sensor 532 for detecting the occurrence of a cleaning event, in some embodiments, a cleaning event detector as described herein may include two or more sensors that operate under the same or different modalities to provide a redundant, more robust system. If, for example, two sensors in a cleaning event detector operate under the same modality (e.g., vibration sensors), then the use of the two sensors may provide for detection of a cleaning event by sensing vibrations using one or both of the two sensors. If, for example, two sensors in a cleaning event detector operate under different modalities (e.g., a vibration sensor and a pressure sensor are provided in connection with the same cleaning event detector), then the detection of a cleaning event may be accomplished by sensing vibrations and/or pressure fluctuations using the two sensors.

Examples of some potentially suitable sensors 532 that may be used in the cleaning event detectors described herein to detect cleaning events at associated hygiene apparatus may include, but are not limited to: pressure sensors, vibration sensors, acoustic sensors, accelerometers, optical proximity sensors, capacitive proximity sensors, flow meters, temperature sensors, magnetic flux/field sensors, electric field sensors, taggant detectors, etc. Some potentially suitable sensors may be obtained from, e.g., Analog Devices, Inc, STMicroelectronics, Inc., Freescale Semiconductor, Inc., and others.

Where, for example, the hygiene apparatus 538 to be monitored using a cleaning event detector 531 is in the form of a dispenser containing, e.g., antiseptic hand sanitizer, the cleaning event detector 531 may take the form of a pressure sensor, e.g., a differential pressure sensor that is attached to the hygiene apparatus 538 such that the cleaning event detector 531 is in direct physical contact with the hygiene apparatus 538. In such an embodiment, pressure exerted on the container of the hygiene apparatus 538 during the dispensing of antiseptic hand sanitizer may be detected by the pressure sensor. That event can then be used to provide an indication that that a cleaning event has occurred at the hygiene apparatus. The pressure sensor may, in some embodiments, be mounted on the dispensing portion of the hygiene apparatus 538 (e.g., on a plunger or other mechanical component on which force is exerted to dispense the solution). In other embodiments, the pressure sensor may be mounted on the underside of a container if, e.g., the hygiene apparatus is in the form of a free-standing dispenser. In still other embodiments, the pressure sensor may be mounted internally within the hygiene apparatus to detect pressure exerted on an internal component (e.g., a reservoir, bladder, etc.) where, for example, the hygiene apparatus automatically dispenses sanitizing solution when the presence of a hand (or other piece of equipment) is detected near a dispensing location. Other potential uses for pressure sensors are also possible.

Embodiments of cleaning event detectors 531 that include a sensor 532 in the form of, e.g., vibration sensor, may be used to detect the occurrence of a cleaning event at a hygiene apparatus 538. A vibration sensor may be used to detect vibration or one or more components of the hygiene apparatus 538 (e.g., vibration of a housing, an actuator used to dispense antiseptic sanitizing solution, a water pipe, etc.). Although not necessarily required, it may be preferred to attach a vibration sensor to its associated hygiene apparatus 538 such that the sensor 532 is in direct physical contact with the hygiene apparatus 538 where it may be better able to detect vibrations associated with a cleaning event. In addition to antiseptic sanitizing solution dispensers, a vibration sensor may also be used to detect vibrations associated with cleaning events at, e.g., soap dispensers, faucets, towelette dispensers, glove dispensers, etc.

Embodiments of cleaning event detectors 531 that include a sensor 532 in the form of, e.g., an acoustic sensor positioned to detect the occurrence of a cleaning event at a hygiene apparatus 538. An acoustic sensor may be used to detect acoustic energy generated during a cleaning event at the associated hygiene apparatus 538. The acoustic energy may, for example, be generated during the dispensing of a variety of materials, e.g., antiseptic sanitizing solutions, soap, water, towelettes, gloves, etc. In other embodiments, the acoustic energy may be generated by use of material such as, e.g., the acoustic energy generated by a health care worker rubbing antiseptic sanitizing solution over their hands, washing hands with water in a sink, etc.

Embodiments of cleaning event detectors 531 that include a sensor 532 in the form of, e.g., an accelerometer positioned to detect the occurrence of a cleaning event at a hygiene apparatus 538. An accelerometer may be used to detect movement of some component of an associated hygiene apparatus 538 during a cleaning event at the hygiene apparatus 538. The movement may, for example, be generated during the dispensing of a variety of materials, e.g., antiseptic sanitizing solutions, soap, water, towelettes, gloves, etc.

Embodiments of cleaning event detectors 531 that include a sensor 532 in the form of, e.g., an optical proximity sensor positioned to detect the occurrence of a cleaning event at a hygiene apparatus 538. An optical proximity sensor may be used to detect a person and/or a piece of equipment in a location in proximity to the sensor 532 that would be indicative of the performance of a cleaning event at the associate hygiene apparatus 538. The optical proximity sensor 532 may operate under reflectance (i.e., optical energy may be reflected from the person and/or equipment) and/or under interruption (i.e., the person and/or equipment may interrupt a beam of optical energy).

Embodiments of cleaning event detectors 531 that include a sensor 532 in the form of, e.g., a capacitive proximity sensor positioned to detect the occurrence of a cleaning event at a hygiene apparatus 538. A capacitive proximity sensor may be used to detect a person and/or a piece of equipment in a location in proximity to the sensor 532 that would be indicative of the performance of a cleaning event at the associate hygiene apparatus 538.

Embodiments of cleaning event detectors 531 that include a sensor 532 in the form of, e.g., a flow sensor positioned to detect the occurrence of a cleaning event at a hygiene apparatus 538. Flow sensors may be used to detect the flow of water, soap, antiseptic sanitizing solutions, etc. that would be indicative of the performance of a cleaning event at the associate hygiene apparatus 538.

Embodiments of cleaning event detectors 531 that include a sensor 532 in the form of, e.g., a temperature sensor positioned to detect the occurrence of a cleaning event at a hygiene apparatus 538. Temperature sensors may be used to detect a temperature change that would be indicative of the performance of a cleaning event at the associate hygiene apparatus 538. For example, the change in temperature of a person's hands, the change in temperature of a water pipe, etc. may all be indicative of the occurrence of a cleaning event.

Embodiments of cleaning event detectors 531 that include a sensor 532 in the form of, e.g., a magnetic field/flux sensor positioned to detect the occurrence of a cleaning event at a hygiene apparatus 538. Magnetic field/flux sensors may be used to detect a change on magnetic field (H) and/or magnetic flux density (B) that would be indicative of the performance of a cleaning event at the associated hygiene apparatus 538. For example, the change in magnetic field and/or flux may be indicative of the occurrence of a cleaning event where the hygiene apparatus 538 includes a motor, solenoid or other actuator that would result in a change in magnetic field and/or flux when activated during a cleaning event.

Embodiments of cleaning event detectors 531 that include a sensor 532 in the form of, e.g., a taggant sensor positioned to detect the occurrence of a cleaning event at a hygiene apparatus 538. A taggant sensor may be used to detect a taggant (i.e., an indicator) that is incorporated into soap, antiseptic sanitizing solution, etc. to allow detection of the use of the material including the taggant (see, e.g., U.S. Pat. No. 5,952,924 (Evans et al.)).

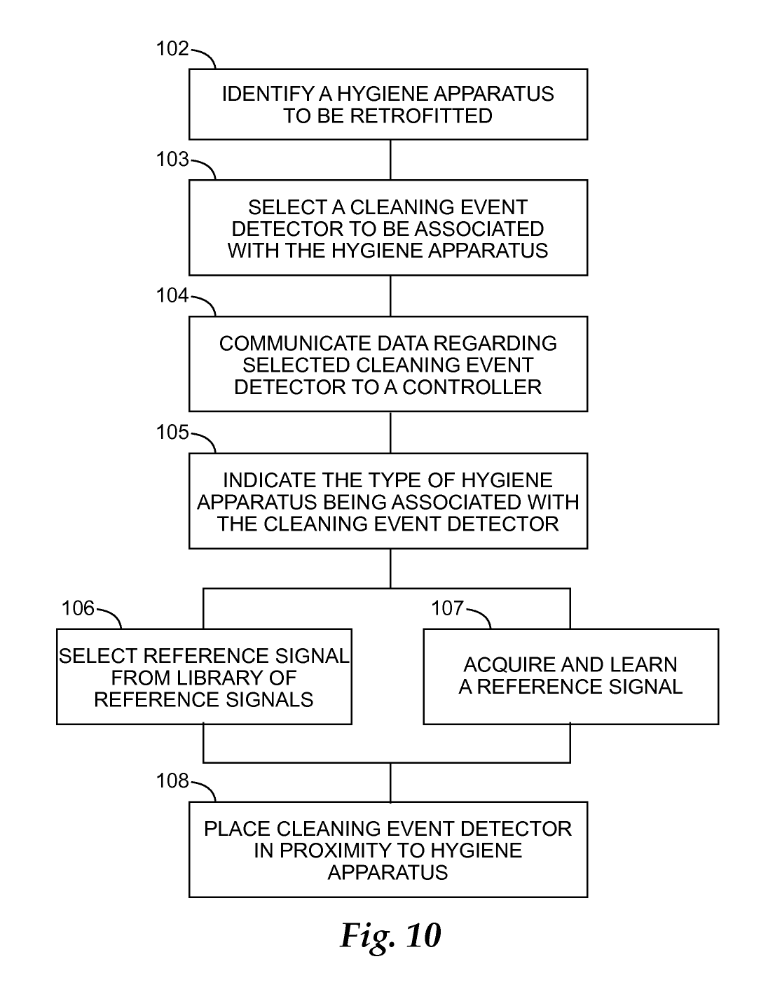

The process of associating a cleaning event detector 531 with an existing hygiene apparatus 538 may be referred to as commissioning of the cleaning event detector 531. In connection with the systems and methods described herein, the commissioning process may include a variety of activities. FIG. 10 depicts some of the actions that may be included in the commissioning process.

As discussed herein, the hygiene protocol monitoring systems and methods may involve the retrofitting of one or more existing hygiene apparatus in a health care facility with a cleaning event detectors to allow for inclusion of the existing hygiene apparatus in the hygiene protocol monitoring. Although the retrofitting process may vary depending on the type of hygiene apparatus being retrofitted, one embodiment of commissioning cleaning event detectors in a retrofitting process will be described in connection with FIG. 10.

The process begins with identifying a hygiene apparatus to be associated with a cleaning event detector (102) in a retrofitting process. As discussed herein, the hygiene apparatus may be any one of a number of different types of hygiene apparatus.

After identifying the type of hygiene apparatus to be associated with a cleaning event detector, the retrofitting process may include selecting a cleaning event detector that is adapted for detecting a cleaning event at the selected hygiene apparatus (103). As discussed herein, the cleaning event detectors used in connection with the systems and methods described herein may include a variety of different sensors capable of detecting different types of events and the cleaning event detector selected for association with a selected hygiene apparatus should include a sensor that is capable of detecting a cleaning event at the selected hygiene apparatus.

Association of a selected cleaning event detector with a selected hygiene apparatus may also involve communicating data regarding the selected cleaning event detector to a controller (104). As described herein, the controller may be a patient zone controller and/or a central system controller. The data communicated to the controller may include, for example, the location of the associated hygiene apparatus within the health care facility, the type of hygiene apparatus associated with the selected cleaning event detector, etc.

Communication of the data to the controller may be accomplished by establishing an optional communication link between the cleaning event detector and a controller. The communication link may be established using the cleaning event detector itself (using, e.g., a communication device in the cleaning event detector) and/or through the use of a secondary communication device that may be located in the hygiene apparatus with which the cleaning event detector is associated, a personal computer, a personal digital assistant (PDA), a cellphone (e.g., a smartphone, etc.), a dedicated commissioning device, etc. Any such communication link may operate in real-time (through, e.g., a wired or wireless communication system, etc.) or it may operate in a batch mode (where the data to be communicated to the controller is accumulated in one or more components (e.g., the commissioning device 560, the person performing the commissioning, etc.), with the data being transferred to the controller at some discrete time after the cleaning event detector has been commissioned.

In some embodiments, the selected cleaning event detector may be commissioned with an indicator as to the type of the hygiene apparatus with which it is being associated (105). That commissioning may involve the use of hardware (e.g., keypads, touch screens, switches, buttons, knobs, voice commands, etc.) and/or software (using an on-board processor and memory in the cleaning event detector). That commissioning may, in some embodiments, be accomplished with the use of a commissioning device which may communicate with the cleaning event detector through a wired or wireless connection to configure the cleaning event detector as desired. As discussed above, the commissioning device 560 may be a dedicated commissioning device, a personal computer, a personal digital assistant (PDA), a cellphone (e.g., a smartphone, etc.), a dedicated commissioning device, etc.

Commissioning of the selected cleaning event detector with an indicator as to the type of the hygiene apparatus may, in some embodiments, be used to set the detection protocols used in connection with the sensor of the cleaning event detector. For example, if a cleaning event detector includes multiple sensors such that it can be used with a variety of different types of hygiene apparatus, the indicator may set the type of sensor to be used (e.g., a pressure sensor, acoustic sensor, accelerometer, etc.).

In addition to commissioning the selected cleaning event detector, in some embodiments the commissioning may also involve the selection of a reference signal to be used to indicate the occurrence of a cleaning event at the hygiene apparatus associated with the selected cleaning event detector. The reference signal is the reference to which a signal detected by the sensor will be compared to make a determination that a cleaning event has occurred, i.e., if the acquired signal is the sufficiently similar to the reference signal, then a determination can be made that a cleaning event has been detected by the cleaning event detector. In some embodiments, the reference signal may be selected from a predetermined library of reference signals (106). The hygiene apparatus may be operated as part of the commissioning to acquire a signal so that the acquired signal can be compared to the reference signal to verify that the selected reference signal is the correct choice (i.e., that detection of a cleaning event is correctly determined using the selected reference signal).

In some embodiments, commissioning of the selected cleaning event detector may involve acquisition and learning of a reference signal (107) that can be used to make a determination that a cleaning event has been detected by the cleaning event detector. The acquisition and learning of a reference signal may, in some embodiments, be the default in those systems in which a reference signal library is not provided. In a commissioning process that involves acquisition and learning to develop a reference signal, the process may involve the use of a template with the acquired signals being analyzed based on one or more of a variety of characteristics, e.g., signal RMS (Root Mean Square), amplitude threshold, signal duration, etc. The commissioning may involve repeated acquisition of signals (i.e., repeated actuation of the hygiene apparatus to simulate a cleaning event) until a reference signal has been developed that can be used to accurately detect a cleaning event.

The association of a selected cleaning event detector with a selected hygiene apparatus will also typically involve placement of the cleaning event detector on or near the hygiene apparatus with which it is to be associated (108). Placement of the cleaning event detector may, in some embodiments, involve attachment of the cleaning event detector in proximity to the hygiene apparatus but not in direct physical contact with the hygiene apparatus. This type of placement of the cleaning event detector may be used where the cleaning event detector includes sensors that do not require direct physical contact with the hygiene apparatus to detect a cleaning event. Because the sensor is used to detect the occurrence of a cleaning event, the sensor of the cleaning event detector is preferably located within a working range of the sensor (where the “working range” is the distance over which the sensor can accurately and repeatably detect the phenomena indicative of a cleaning event, e.g., acoustic energy, vibration, etc.). Examples of this type of cleaning event detector may include, e.g., cleaning event detectors that rely on acoustic sensors, optical sensors, capacitive proximity sensors, etc. that are capable of detecting a cleaning event without requiring direct physical contact with the hygiene apparatus. For example, the cleaning event detector may be placed on a wall or other object that is close to the hygiene apparatus to be monitored by the cleaning event detector.

In other embodiments, placement of the cleaning event detector may involve placing the cleaning event detector in direct physical contact with the hygiene apparatus with which the cleaning event detector is to be associated. By “direct physical contact” as used in describing the placement of the cleaning event detector, it is meant that the cleaning event detector (or at least components of the cleaning event detector) physically contacts the hygiene apparatus. For example, the cleaning event detector may be mounted on or in the housing of a soap or antiseptic cleaning solution dispenser, on the pipes feeding a faucet of sink, on the housing of a towelette or sterile glove dispenser, etc. As a result, activity at the hygiene apparatus during the occurrence of a cleaning event can be directly detected by the sensor(s) of the cleaning event detector.

The process of commissioning a cleaning event detector may also involve confirming acceptable operation of the cleaning event detector such that the cleaning event detector accurately detects the occurrence of a cleaning event and communicates that information to a controller for monitoring of hygiene protocol compliance at the hygiene apparatus associated with the cleaning event detector.

The use of a retrofitted hygiene station (i.e., a commissioned cleaning event detector and its associated hygiene apparatus) in a system that includes one or more patient zone controllers is, after the commissioning process, preferably the same as discussed for the hygiene stations described in connection with the system of FIG. 1 above. The patient zone controller 20 in such a system may be linked to a hygiene station 30 that is, in fact, a retrofitted hygiene station as described herein and the retrofitted hygiene station may be linked to a patient zone controller as can any other hygiene station described herein. The process of establishing that link and using the link to monitor the hygiene protocol compliance will preferably operate the same as for a hygiene station that includes components that allow it to detect a cleaning event without the need for a retrofitted cleaning event detector.

As also discussed herein, the systems and methods for monitoring hygiene protocol compliance may, in some embodiments, be configured to allow for selection/modification of the hygiene protocols to be applied to cleaning events as detected by cleaning event detectors. Selection of the hygiene protocols to be applied by a cleaning event detector and/or within any particular patient zone may be based on a variety of one or more different factors as described herein, e.g., patient-based criteria, environmental criteria, historical hygiene protocol compliance rate, etc.

The selection of hygiene protocols to be applied within a patient zone may be accomplished within a patient zone controller (in those systems that include a patient zone controller) or be driven by one or more devices external from the patient zone controller. Similarly, the selection of hygiene protocols to be applied at a selected retrofitted hygiene station may be accomplished within the retrofitted hygiene station itself or be accomplished using one or more devices external from the retrofitted hygiene station (e.g., a commissioning device, etc.). In some embodiments, the hygiene protocol selection may be accomplished locally (e.g., at the patient zone controller, at the hygiene station, etc.) using any suitable technique, e.g., keypad, touch screens, switches, buttons, knobs, voice commands, etc. In other embodiments, the selection process may be performed using an external device such as a dedicated commissioning/programming device, personal digital assistant (PDA), cell phone, computer, etc.

As described herein, the various components in the systems described herein may communicate information to each other using any suitable technology or combinations of two or more technologies. In some embodiments, the different components may communicate with each other wirelessly using any suitable wireless communication mode such as RF signals (e.g., RFID-based systems, etc.), acoustic energy (e.g., ultrasonic energy, etc.), optical energy (e.g., infrared, etc.). In other embodiments, the communication links may be wired links using cables (e.g., USB, Firewire, optical cables, etc.).

Further, the various components may provide data to each other either passively and/or actively. Typically, however, at least one of the components in any pair of communicating components includes active communication technology in the form of a device capable of receiving data from at least one other component. For example, a patient zone controller may include an optical reader (one example of an active communication device) while the hygiene station to which it is linked includes data in the form of optically readable indicia (e.g., a barcode, microdots, color coding, etc.). As a result, communication between the patient zone controller and the linked hygiene station may be accomplished by using the optical reader (an active device) of the patient zone controller to obtain data from the optical indicia (a passive device) of the hygiene station to establish the link between the two components. Such communication between components is only one example of a one-way communication system.

Another example of a one-way communication between components may be found in, e.g., RFID technology. For example, a patient zone controller may include a communication device in the form of an RF device capable of generating an RF field (one form of transmitting data) and receiving data from RFID tags activated by the RF field. One or more other components in the system that includes the patient zone controller, such as a hygiene station and/or transient credential, may include an RFID tag that, in the presence of the RF field, is capable of communicating data stored on the RFID tag. In such a system, the RFID tag, for the purposes of the systems and methods described herein, is also deemed to include a communication device in the form of a transceiver, i.e., a device that can both receive data (the activating RF signal) and transmit data (the data that is transmitted to an RF receiver on the patient zone controller). Although the communication device of the RFID tag itself is not active, i.e., it is not activated in the absence of an RF field, it is active for the purposes of the systems and methods described herein because it can transmit and receive data in the presence of an activating RF field.

In still other embodiments of the systems and methods described herein, two components of the patient zone controller, the linked hygiene station, and the transient credential may include communication devices capable of both transmitting data and receiving data. For example, in some systems, the patient zone controller and the linked hygiene station may both include a two-way communication device capable of both transmitting data and receiving data while the transient credential includes only the ability to provide data to the patient zone controller and/or linked hygiene station. In other systems, the patient zone controller and the transient credential may include two-way communication devices, while the linked hygiene station includes only the ability to provide data to the patient zone controller and/or transient credential.

Although a variety of communication schemes have been described herein, many other variations exist and can be used in connection with the systems and methods described herein, i.e., the described communication schemes should not be considered as the only communication schemes for use with the systems and methods described herein.

In addition to the embodiments described above, some additional embodiments of the systems and methods described herein are also contemplated as described in the following paragraphs.

In a seventh aspect, some embodiments of a method of commissioning a hygiene station in a hygiene monitoring system may include: associating a first cleaning event detector with a first hygiene apparatus, wherein the first cleaning event detector comprises a sensor operable to detect a cleaning event performed at the first hygiene apparatus; communicating data regarding the first cleaning event detector to a controller through a wireless communication link; selecting a cleaning event detection protocol for the first cleaning event detector, wherein the selecting comprises choosing a cleaning event detection protocol from two or more different cleaning event detection protocols; associating a second cleaning event detector with a second hygiene apparatus, wherein a cleaning event performed at the second hygiene apparatus is of a different type than a cleaning event performed at the first hygiene apparatus, and wherein the second cleaning event detector comprises a sensor operable to detect a cleaning event performed at the second hygiene apparatus; communicating data regarding the second cleaning event detector to a controller through a wireless communication link; and selecting a cleaning event detection protocol for the second cleaning event detector, wherein the selecting comprises choosing a cleaning event detection protocol from the two or more different cleaning event detection protocols.

In some embodiments of methods according to the seventh aspect, the first cleaning event detector comprises a housing containing the sensor, a communication device operably connected to the sensor, and a power supply located in the housing and operably connected to the sensor and the communication device; and wherein associating the first cleaning event detector with the first hygiene apparatus comprises attaching the first cleaning event detector such that the sensor of the first cleaning event detector is in direct physical contact with the first hygiene apparatus. In some embodiments, the second cleaning event detector comprises a housing containing the sensor, a communication device operably connected to the sensor, and a power supply located in the housing and operably connected to the sensor and the communication device; and wherein associating the second cleaning event detector with the second hygiene apparatus comprises positioning the second cleaning event detector such that the sensor of the second cleaning event detector is located within its working range relative to the second hygiene apparatus, but is not in direct physical contact with the second hygiene apparatus.

In some embodiments of methods according to the seventh aspect, the first cleaning event detector comprises a housing containing the sensor, a communication device operably connected to the sensor, and a power supply located in the housing and operably connected to the sensor and the communication device; and wherein associating the first cleaning event detector with the first hygiene apparatus comprises positioning the first cleaning event detector such that the sensor of the first cleaning event detector is located within its working range relative to the first hygiene apparatus, but is not in direct physical contact with the first hygiene apparatus.

In some embodiments of methods according to the seventh aspect, the data communicated to the controller regarding the first cleaning event detector comprises data indicative of the location of the first cleaning event detector.

In some embodiments of methods according to the seventh aspect, the data communicated to the controller regarding the first cleaning event detector comprises data indicative of a type of hygiene apparatus for the first hygiene apparatus.

In some embodiments of methods according to the seventh aspect, the data communicated to the controller regarding the first cleaning event detector comprises the cleaning event detection protocol selected for the first cleaning event detector.

In some embodiments of methods according to the seventh aspect, the selected cleaning event detection protocol for the first hygiene apparatus comprises a learned reference signal, and wherein the learned reference signal is defined by: operating the first hygiene apparatus; acquiring a sample signal by using the first cleaning event detector to detect operation of the first hygiene apparatus; and characterizing one or more features of the sample signal to define a learned reference signal to be used to determine when a cleaning event occurs at the first hygiene apparatus using the learned reference signal.

In some embodiments of methods according to the seventh aspect, the first hygiene apparatus and the second hygiene apparatus are selected from the group consisting of: a soap dispenser, a soap and water dispenser, antiseptic hand sanitizer dispenser, towelette dispenser, glove dispenser, and UV disinfectant station.

In some embodiments of methods according to the seventh aspect, the sensor of the first cleaning event detector is selected from the group consisting of: a vibration sensor, an accelerometer, a acoustic sensor, a pressure sensor, an optical proximity sensor, a capacitive proximity sensor, a flow meter, a temperature sensor, a magnetic flux/field sensor, an electric field sensor, and a taggant detector.

In some embodiments of methods according to the seventh aspect, the first cleaning event detector comprises a transient credential detector, and wherein the method comprises detecting a transient credential and associating the transient credential with the detected cleaning event.

In an eighth aspect, some embodiments of a system for monitoring hygiene protocol compliance in a health care facility as described herein include: a plurality of hygiene stations, wherein each hygiene station of the plurality of hygiene stations comprises a communication device, and wherein at least one hygiene station of the plurality of hygiene stations comprises a retrofitted hygiene station that comprises a cleaning event detector and an associated hygiene apparatus; a central controller, wherein the plurality of hygiene stations are operably connected to the central controller through a communication link that comprises the communication devices in the plurality of hygiene stations; and a plurality of transient credentials, wherein each transient credential optionally comprises a communication device. Each hygiene station of the plurality of hygiene stations is configured to detect the occurrence of a cleaning event at the hygiene station, identify a transient credential to associate with the detected cleaning event, and transmit data identifying the transient credential associated with the cleaning event to the central controller.

In some embodiments of systems according to the eighth aspect, the system further comprises a commissioning device configured to commission the retrofitted hygiene station by associating a selected cleaning event detector with a selected hygiene apparatus.

In some embodiments of systems according to the eighth aspect, the cleaning event detector of the retrofitted hygiene station comprises a housing containing a sensor, a communication device operably connected to the sensor, and a power supply located in the housing and operably connected to the sensor and the communication device; and wherein the sensor of the cleaning event detector is in direct physical contact with the hygiene apparatus.

In some embodiments of systems according to the eighth aspect, the cleaning event detector of the retrofitted hygiene station comprises a housing containing a sensor, a communication device operably connected to the sensor, and a power supply located in the housing and operably connected to the sensor and the communication device; and wherein the sensor of the cleaning event detector is located within its working range relative to the hygiene apparatus, but not in direct physical contact with the hygiene apparatus.

In some embodiments of systems according to the eighth aspect, the system further comprises a patient zone controller that optionally comprises a communication device, wherein the system comprises data associating the patient zone controller with only one selected patient, and wherein the patient zone controller is linked to a hygiene station of the plurality of hygiene stations, and wherein the patient zone controller is configured to define a patient zone proximate the selected patient. In some embodiments, the system is configured to: determine the occurrence of a cleaning event at the linked hygiene station; associate a transient credential of the plurality of transient credentials with the cleaning event; and store data identifying the transient credential associated with the cleaning event in the patient zone controller. In further embodiments, the patient zone controller may be configured to: detect entry and/or exit of a transient credential of the plurality of credentials relative to the patient zone; and determine if the detected transient credential is associated with a cleaning event at the linked hygiene station, optionally within a selected time period relative to detection of entry and/or exit of the transient credential relative to the patient zone. In still further embodiments, the patient zone controller may be configured to store compliance data, wherein the compliance data comprises data indicative of the determination that the transient credential detected in the patient zone is or is not associated with the cleaning event at the linked hygiene station optionally within the selected time period.

In some embodiments of systems according to the eighth aspect, the system may be configured to: determine the occurrence of a cleaning event at the linked hygiene station; associate a transient credential of the plurality of transient credentials with the cleaning event; store data identifying the transient credential associated with the cleaning event in the transient credential. In some embodiments, the system may be configured to: detect entry and/or exit of a transient credential of the plurality of credentials relative to the patient zone; and determine if the detected transient credential is associated with a cleaning event at the linked hygiene station, optionally within a selected time period relative to detection of entry and/or exit of the transient credential relative to the patient zone. In further embodiments, the detection of entry into the patient zone may be performed in the transient credential. In still further embodiments, the transient credential may be configured to store compliance data, wherein the compliance data comprises data indicative of the determination that the transient credential detected in the patient zone is or is not associated with the cleaning event at the linked hygiene station, optionally within the selected time period.

In some embodiments of systems according to the eighth aspect, the system is configured to: determine the occurrence of a cleaning event at the linked hygiene station; associate a transient credential of the plurality of transient credentials with the cleaning event; and store data identifying the transient credential associated with the cleaning event in the linked hygiene station. In some embodiments, the system is configured to: detect entry and/or exit of a transient credential of the plurality of credentials relative to the patient zone; and determine if the detected transient credential is associated with a cleaning event at the linked hygiene station, optionally within a selected time period relative to detection of entry and/or exit of the transient credential relative to the patient zone. In further embodiments, the linked hygiene station may be configured to store compliance data, wherein the compliance data comprises data indicative of the determination that the transient credential detected in the patient zone is or is not associated with the cleaning event at the linked hygiene station, optionally within the selected time period.

In some embodiments of systems according to the eighth aspect, the patient zone controller comprises a first patient zone and a second patient zone, wherein the first patient zone is different than the second patient zone. In some embodiments, the first patient zone is larger than the second patient zone. In further embodiments, the patient zone controller defines the first patient zone and the second patient zone at the same time, wherein the first patient zone and the second patient zone define a multi-tiered patient zone. In some embodiments, the patient zone controller selects one of the first patient zone and a second patient zone based on criteria associated with the selected patient. In some embodiments, the patient zone controller selects one of the first patient zone and a second patient zone based on a determination that the selected patient is moving between a first location and second location within a health care facility.

In some embodiments of systems according to the eighth aspect, the linked hygiene station is located within the patient zone. In some embodiments, the patient zone controller is linked to two or more hygiene stations of the plurality of hygiene stations at the same time. In further embodiments, at least one of the two or more hygiene stations linked to the patient zone controller is located within the patient zone.

In some embodiments of systems according to the eighth aspect, the system is configured to: detect entry and/or exit of a transient credential entry of the plurality of transient credentials relative to the patient zone; and determine if the detected transient credential is associated with a cleaning event at the linked hygiene station, optionally within a selected time period relative to detection of entry and/or exit of the transient credential relative to the patient zone. In some embodiments, the patient zone controller is configured to detect the entry and/or exit. In further embodiments, the patient zone controller is configured to make the determination that the detected transient credential is associated with a cleaning event at the linked hygiene station. In some embodiments, the transient credential is configured to detect the entry and/or exit. In some embodiments, the transient credential is configured to make the determination that the detected transient credential is associated with a cleaning event at the linked hygiene station.

In some embodiments of systems according to the eighth aspect, the central controller is configured to store compliance data, wherein the compliance data comprises data indicative of the determination that the transient credential detected in the patient zone is or is not associated with the cleaning event at the linked hygiene station, optionally within the selected time period.

The complete disclosure of the patents, patent documents, and publications cited herein are incorporated by reference in their entirety as if each were individually incorporated.

Exemplary embodiments of hygiene monitoring systems and methods have been discussed and reference has been made to possible variations. These and other variations and modifications will be apparent to those skilled in the art without departing from the scope of the invention, and it should be understood that the invention is not limited to the illustrative embodiments set forth herein. Accordingly, the invention is to be limited only by the claims provided below and equivalents thereof.

1. A system for monitoring hygiene practices, the system comprising:
a plurality of hygiene stations, wherein each hygiene station of the plurality of hygiene stations comprises on-board memory operably connected to a communication device, wherein at least some data transmitted by the communication device is stored in the on-board memory of the hygiene station;
a patient zone controller configured to define a patient zone proximate the selected patient, wherein the patient zone controller is linked to a hygiene station of the plurality of hygiene stations, wherein the patient zone controller comprises on-board memory operably connected to a communication device, wherein at least some data transmitted by the communication device is stored in the on-board memory of the patient zone controller, and wherein the patient zone controller is associated with only one selected patient;
a plurality of transient credentials, wherein each transient credential comprises on-board memory operably connected to a communication device, wherein at least some data transmitted by the transceiver is stored in the on-board memory of the transient credential, and wherein the transient credential is associated with a transient object.

2. A system according to claim 1, wherein the system is configured to:
detect the occurrence of a cleaning event at the linked hygiene station;
associate a transient credential of the plurality of transient credentials with the cleaning event;
store data identifying the transient credential associated with the cleaning event in the patient zone controller.

3. A system according to claim 1, wherein the patient zone controller is configured to:
detect entry of a transient credential of the plurality of credentials into the patient zone defined by the patient zone controller;
and optionally to determine if the detected transient credential is associated with a cleaning event at the hygiene station linked to the patient zone controller, optionally within a selected time period relative to detection of the entry.

4. A system according to claim 1, wherein each transient credential of the plurality of transient credentials is configured to:
detect entry of the transient credential into the patient zone defined by the patient zone controller;
and optionally to determine if the detected transient credential is associated with a cleaning event at the hygiene station linked to the patient zone controller, optionally within a selected time period relative to detection of the entry.

5. A system according to claim 1, wherein the linked hygiene station is configured to:
detect entry of a transient credential of the plurality of credentials into the patient zone defined by the patient zone controller;
and optionally to determine if the detected transient credential is associated with a cleaning event at the linked hygiene station linked to the patient zone controller, optionally within a selected time period relative to detection of the entry.

6. A system according to claim 1, wherein the patient zone controller is configured to define a first patient zone and a second patient zone, wherein the first patient zone is different than the second patient zone.

7. A system according to claim 6, wherein the patient zone controller is configured to define the first patient zone and the second patient zone at the same time, wherein the first patient zone and the second patient zone define a multi-tiered patient zone.

8. A system according to claim 6, wherein the patient zone controller is configured to select one of the first patient zone and a second patient zone based on criteria associated with the selected patient associated with the patient zone controller.

9. A system according to claim 1, wherein the system further comprises a central controller, and wherein at least one of the linked hygiene station, the patient zone controller, and the transient credential is operably connected to the central controller, and wherein the system comprises a plurality of patient zone controllers.

10. A system according to claim 9, wherein the patient zone controller is configured to:
detect entry of a transient credential of the plurality of credentials into the patient zone defined by the patient zone controller; and
communicate data to the central controller indicating entry of the transient credential into the patient zone and association of the transient credential with a cleaning event.

11. A system according to claim 9, wherein each transient credential of the plurality of transient credentials is configured to:
detect entry of the transient credential into the patient zone defined by the patient zone controller; and
communicate data to the central controller indicating entry of the transient credential into the patient zone and association of the transient credential with a cleaning event.

12. A system according to claim 9, wherein the linked hygiene station is configured to:
detect entry of a transient credential of the plurality of credentials into the patient zone defined by the patient zone controller; and
communicate data to the central controller indicating entry of the transient credential into the patient zone and association of the transient credential with a cleaning event.

13. A system according to claim 9, wherein the central controller is configured to store compliance data, wherein the compliance data comprises data indicative of the determination that the transient credential detected in the patient zone is or is not associated with the cleaning event at the linked hygiene station, optionally within the selected time period.

14. A method of monitoring hygiene compliance, the method comprising:
associating a patient zone controller with a selected patient;
defining a patient zone using a patient zone controller;
linking a hygiene station to the patient zone controller;
detecting entry of a transient credential into the patient zone defined by the patient zone controller; and
determining if the transient credential is associated with a cleaning event at the linked hygiene station.

15. A method according to claim 14, wherein linking the hygiene station to the patient zone controller comprises communication between the linked hygiene station and the patient zone controller.

16. A method according to claim 14, wherein linking the hygiene station to the patient zone controller occurs when the hygiene station enters the patient zone defined by the patient zone controller.

17. A method according to claim 14, wherein the linking comprises determining if the hygiene station is acceptable for the selected patient associated with the patient zone controller.

18. A method according to claim 14, wherein the patient zone controller defines a first patient zone and a second patient zone, wherein the first patient zone is different than the second patient zone.

19. A method according to claim 14, wherein the method further comprises:
detecting the occurrence of a cleaning event at the linked hygiene station;
associating the transient credential detected as entering the patient zone with the cleaning event.

20. A method according to claim 14, wherein the patient zone controller detects entry of the transient credential into the patient zone defined by the patient zone controller.

21. A method according to claim 20, wherein the patient zone controller reports the detected entry of the transient credential into the patient zone defined by the patient zone controller to a central controller.

22. A method according to claim 14, wherein the transient credential detects entry of the transient credential into the patient zone defined by the patient zone controller.

23. A method according to claim 22, wherein the transient credential reports the detected entry of the transient credential into the patient zone defined by the patient zone controller to a central controller.

24. A method according to claim 23, wherein the central controller determines if the transient credential is associated with a cleaning event at the hygiene station linked to the patient zone controller, optionally within a selected time period relative to detection of the entry.

25. A method according to claim 14, wherein the linked hygiene station detects entry of the detected transient credential into the patient zone defined by the patient zone controller.

26. A method according to claim 25, wherein the linked hygiene station determines if the detected transient credential is associated with a cleaning event at the linked hygiene station linked to the patient zone controller, optionally within a selected time period relative to detection of the entry.

27. A method according to claim 25, wherein the linked hygiene station reports the detected entry of the transient credential into the patient zone defined by the patient zone controller to a central controller.

28. A method according to claim 27, wherein the central controller determines if the detected transient credential is associated with a cleaning event at the hygiene station linked to the patient zone controller, optionally within a selected time period relative to detection of the entry.

29. A method of selecting a hygiene protocol for use in a patient zone, the method comprising:
associating a selected patient with a patient zone;
identifying a patient-based factor associated with the selected patient;
selecting a hygiene protocol to apply in the patient zone based on the identified patient-based factor; and
applying the selected hygiene protocol upon entry of a transient credential into the patient zone.

30. A method according to claim 29, wherein the patient-based factor is selected from the group consisting of: the health of the patient, the type of illness or condition from which the patient suffers, and whether the patient is moving through the facility.

31. A method of selecting a hygiene protocol for use in a patient zone, the method comprising:
associating a selected patient with a patient zone;
identifying an environmental factor associated with the environment in which the patient zone is located;
selecting a hygiene protocol to apply in the patient zone based on the identified environmental factor; and
applying the selected hygiene protocol upon entry of a transient credential into the patient zone.

32. A method according to claim 31, wherein the environmental factor is selected from the group consisting of: the type of health care facility in which the patient zone is located, the time of day, the day of the week, the time of year, the existence of an outbreak of contagious illness near the patient zone; and the existence of an outbreak of contagious illnesses in the community in which the patient zone is located.

33. A method of selecting a hygiene protocol for use in a patient zone, the method comprising:
associating a selected patient with a patient zone;
optionally identifying a location of the patient zone;
identifying the historical hygiene protocol compliance rate of the location in which the patient zone is located; and
selecting a hygiene protocol to apply in the patient zone based on the identified historical hygiene protocol compliance rate; and
applying the selected hygiene protocol upon entry of a transient credential into the patient zone.

34. A method of selecting a hygiene protocol for use in a patient zone, the method comprising:
detecting entry of a transient credential into a patient zone;
identifying a factor associated with the transient credential entering the patient zone;
selecting a hygiene protocol to apply in the patient zone to entry of the transient credential based on the factor associated with the entering transient credential; and
applying the selected hygiene protocol upon entry of a transient credential into the patient zone.

35. A method according to claim 34, wherein the factor associated with the transient credential is selected from the group consisting of: a historical hygiene protocol compliance rate associated with the transient credential, a group associated with the transient credential, and a historical hygiene protocol compliance rate associated with a group associated with the transient credential.
